(19) United States
(12) Patent Application Publication
(10) Pub. No.: US 2021/0049998 A1
(43) Pub. Date: Feb. 18, 2021

(54) INFORMATION PROCESSING APPARATUS, INFORMATION PROCESSING METHOD, AND PROGRAM

(71) Applicant: Sony Corporation, Tokyo (JP)

(72) Inventors: Hideo NAGASAKA, Tokyo (JP); Kei TAKAHASHI, Tokyo (JP); Junichi SHIMIZU, Tokyo (JP)

(73) Assignee: Sony Corporation, Tokyo (JP)

(21) Appl. No.: 16/978,769

(22) PCT Filed: Feb. 15, 2019
(86) PCT No.: PCT/JP2019/005577

§ 371 Date: Sep. 8, 2020

Related U.S. Application Data
(60) Provisional application No. 62/643,409, filed on Mar. 15, 2018.

(51) Int. Cl. G10L 13/047; G06K 9/00

(52) U.S. Cl. CPC G10L 13/047; G06K 9/00335

(57) ABSTRACT

To realize appropriately achieving input to two or more software applications in an information processing system that outputs speech corresponding to a request from a software application and recognizes a gesture made by a user who hears the speech to perform input to the software application.

There is provided an information processing apparatus including a reception unit configured to be capable of obtaining information regarding a request from two or more software applications, a speech control unit configured to control an output of speech corresponding to the request, a gesture recognition unit configured to recognize a gesture made by a user with respect to the speech corresponding to the request, and an input processing unit configured to calculate information regarding an input by the user in response to the request by analyzing the gesture on the basis of an algorithm uniformly defined for the two or more software applications.

### TECHNICAL FIELD

The present disclosure relates to an information processing apparatus, an information processing method, and a program.

### BACKGROUND ART

In recent years, users have been able to perform input to software (e.g., such as applications) using various ways. In one example, a technique has been developed for inputting software on the basis of a gesture made by a user.

In one example, Patent Document 1 below discloses a technique used in an information processing system that outputs speech corresponding to a request from a software application and recognizes a gesture made by a user who hears the speech to perform input to the software application. The technique is capable of canceling the input based on a gesture if necessary when the user makes the gesture. Thus, the technique disclosed in Patent Document 1 is capable of preventing the user's unintentional input due to an erroneous gesture.

### CITATION LIST

### Patent Document

Patent Document 1: Japanese Patent Application Laid-Open No. 2017-207890

### SUMMARY OF THE INVENTION

Problems to be Solved by the Invention

However, the technique or the like disclosed in Patent Document 1 fails to implement appropriately input to two or more software applications in some cases. In one example, if software applications capable of being input by a gesture increase in number, a gesture is often defined individually for each software application. Then, the contents of the input performed by the same gesture can differ depending on the software applications, so the user is necessary to understand a gesture defined for each software application to make a gesture corresponding to the software application to be input.

The present disclosure is made in view of the above circumstances. The present disclosure provides a novel and improved information processing apparatus, information processing method, and program, capable of appropriately achieving input to two or more software applications in an information processing system that outputs speech corresponding to a request from a software application and recognizes a gesture made by a user who hears the speech to perform input to the software application.

### Solutions to Problems

According to the present disclosure, there is provided an information processing apparatus including a reception unit configured to be capable of obtaining information regarding a request from two or more software applications, a speech control unit configured to control an output of speech corresponding to the request, a gesture recognition unit configured to recognize a gesture made by a user with respect to the speech corresponding to the request, and an input processing unit configured to calculate information regarding an input by the user in response to the request by analyzing the gesture on the basis of an algorithm uniformly defined for the two or more software applications.

Further, according to the present disclosure, there is provided an information processing method executed by a computer, the method including obtaining information regarding a request from two or more software applications, controlling an output of speech corresponding to the request, recognizing a gesture made by a user with respect to the speech corresponding to the request, and calculating information regarding an input by the user in response to the request by analyzing the gesture on the basis of an algorithm uniformly defined for the two or more software applications.

Further, according to the present disclosure, there is provided a program causing a computer to implement, obtaining information regarding a request from two or more software applications, controlling an output of speech corresponding to the request, recognizing a gesture made by a user with respect to the speech corresponding to the request, and calculating information regarding an input by the user in response to the request by analyzing the gesture on the basis of an algorithm uniformly defined for the two or more software applications.

### BRIEF DESCRIPTION OF DRAWINGS

FIG. 1 is a block diagram illustrating a configuration example of an information processing system according to the present embodiment.

FIG. 2 is a sequence diagram showing an example of a procedure of processing regarding input that is performed by each device according to the present embodiment.

FIG. 3 is a block diagram illustrating a functional configuration example of a first device according to the present embodiment.

FIG. 4 is a block diagram illustrating a functional configuration example of a second device according to the present embodiment.

FIG. 5 is a table showing an example of the relationship between a gesture and input contents.

FIG. 6 is a sequence diagram showing an example of a procedure of processing by a first device and a user's motion.

FIG. 7 is an image diagram of a graphical user interface (GUI) after input is performed by the series of processing steps shown in FIG. 6 in a case of being provided with the GUI for input.

FIG. 8 is a table showing an example of the relationship between a gesture and input contents.

FIG. 9 is a sequence diagram showing an example of a procedure of processing by a first device and a user's motion.

FIG. 10 is an image diagram of a GUI after input is performed by the series of processing steps shown in FIG. 9 in a case of being provided with the GUI for input.

FIG. 11 is a table showing an example of the relationship between a gesture and input contents.

FIG. 12 is a sequence diagram showing an example of a procedure of processing by a first device and a user's motion.

FIG. 13 is an image diagram of a GUI after input is performed by the series of processing steps shown in FIG. 12 in a case of being provided with the GUI for input.

FIG. 14 is a table showing an example of the relationship between a gesture and input contents.

FIG. 15 is a sequence diagram showing an example of a procedure of processing by a first device and a user's motion.

FIG. 16 is an image diagram of a GUI after input is performed by the series of processing steps shown in FIG. 15 in a case of being provided with the GUI for input.

FIG. 17 is a table showing an example of the relationship between a software application and a component included in the software.

FIG. 18 is a diagram illustrating a specific example of a GUI used for changing an algorithm for a component “RadioButton”.

FIG. 19 is a diagram illustrating a specific example of a GUI used for changing an algorithm for a component “RadioButton”.

FIG. 20 is a diagram illustrating a specific example of a GUI used for registering a new gesture.

FIG. 21 is a diagram illustrating a specific example of a GUI used for registering a new gesture.

FIG. 22 is a diagram illustrating a specific example of a GUI used for registering a new gesture.

FIG. 23 is a flowchart showing an example of processing in a case where payment or the like is conducted using a gesture by applying the present embodiment to an automatic vending machine system.

FIG. 24 is a flowchart showing an example of processing in a case where payment or the like is conducted using a gesture by applying the present embodiment to an automatic vending machine system.

FIG. 25 is a flowchart showing an example of processing in a case where a gesture is used to, for example, achieve unlocking or the like of a car or accommodation facility by applying the present embodiment to a rental system for automobiles or accommodation facilities.

FIG. 26 is a block diagram illustrating a hardware configuration example of an information processing apparatus that implements a first device or a second device according to the present embodiment.

### MODE FOR CARRYING OUT THE INVENTION

Hereinafter, a preferred embodiment of the present disclosure will be described in detail with reference to the appended drawings. Note that, in this specification and the appended drawings, components that have substantially the same function and configuration are denoted with the same reference numerals, and repeated explanation of these structural elements is omitted.

Note that the description is given in the following order.

1. Overview

2. System configuration example

3. Functional configuration example of device

4. Example of input

5. Modification or the like of algorithm

6. Practical example

7. Hardware configuration example of device

8. Concluding remark

<1. Overview>

An overview of the present disclosure is now described.

With the development of a voice assistant, users are able to interact with a device to achieve various purposes. However, in a situation in which a user is incapable of uttering a word, the user is unable to use the voice assistant to perform input, so the user performs input, in one example, using a chat assistant or using a graphical user interface (GUI) provided in a mobile device such as smartphones. In this case, for example, the user is necessary to take out a mobile device such as smartphones to perform an input operation. In addition, dangerous conducts such as performing an input operation while moving are triggered.

Therefore, in recent years, as disclosed in Patent Document 1, a technique has been developed for inputting software on the basis of a gesture made by a user. However, the technique or the like disclosed in Patent Document 1 fails to implement appropriately input to two or more software applications in some cases. In one example, if software applications capable of being input by a gesture increase in number, a gesture is often defined individually for each software application. Then, the contents of the input performed by the same gesture can differ depending on the software applications, so the user is necessary to understand a gesture defined for each software application to make a gesture corresponding to the software application to be input.

Although it is possible to give an account of a way to perform input by a gesture to the user, using a speech guide before performing input by a gesture, it often takes a considerable amount of time for giving an account. In addition, giving an account in detail of a way to perform input by a gesture to the user using a speech guide is difficult in some cases.

Those who conceived the present disclosure have devised the technology according to the present disclosure in view of the above-mentioned circumstances. The information processing apparatus according to the present disclosure is capable of obtaining information regarding a request from two or more software applications, recognizing a gesture made by a user who hears speech corresponding to the request, and analyzing the gesture on the basis of algorithm uniformly defined for the two or more software applications. Thus, information regarding the user input to the request is calculated.

Thus, in an information processing system that outputs speech corresponding to a request from a software application and recognizes a gesture made by a user who hears the speech to perform input to the software application, the present disclosure allows input to two or more software applications to be more appropriately achieved. More specifically, incorporating a common rule understandable easily by users into the algorithm mentioned above for two or more software applications makes it possible for the user to understand the common rule to perform the input to the two or more software applications with ease. An embodiment of the present disclosure is now described in detail.

<2. System configuration example>

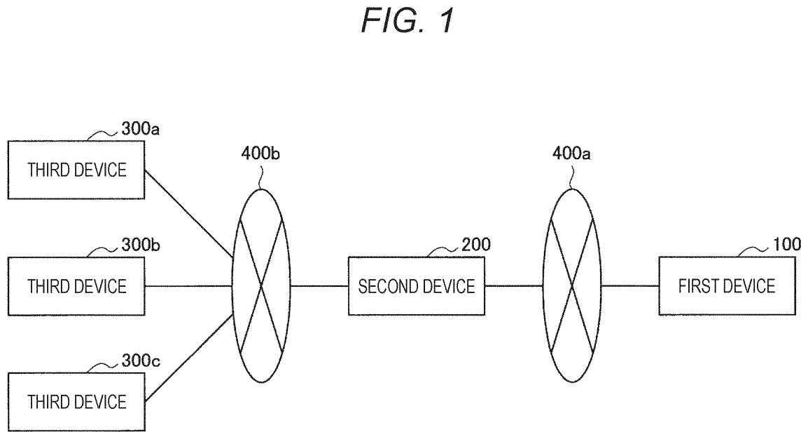

The above description is given of an overview of the present disclosure. An exemplary configuration of the information processing system according to an embodiment of the present disclosure is now described with reference to FIG. 1. FIG. 1 is a block diagram illustrating a configuration example of an information processing system according to the present embodiment.

As illustrated in FIG. 1, the information processing system according to the present embodiment includes a first device 100, a second device 200, and two or more third devices 300 (third devices 300a to 300c in the example of FIG. 1). Then, the first device 100 and the second device 200 are connected via a network 400a. The second device 200 and each of the two or more third devices 300 are connected via a network 400b.

The third device 300 is the information processing apparatus in which a software application to be input is executed in the information processing system according to the present embodiment. In one example, the third device 300 is a mobile device such as a smartphone operated by the user, various servers, or the like. The third device 300 executes various software applications to provide various services for the user. Moreover, the type of the third device 300 is not limited thereto. In addition, the information processing system according to the present embodiment is provided with two or more third devices 300, but the number of the third devices 300 is not limited to a particular number (e.g., even one of the third device 300 is usable). The third device 300 transmits request information used for requesting the input by the user to the second device 200 upon processing the software application. Then, the second device 200 and the first device 100 perform the processing regarding the input, and the third device 300 receives the input information including the input-related information from the second device 200. This makes it possible for the third device 300 to execute the processing regarding the software application on the basis of the input information.

In this regard, the request in the processing on the software application executed by the third device 300 includes a request for selecting one or two or more items from two or more items, a request for changing the states of one or two or more items, a request for selecting one value from continuous values, or the like (but is not limited thereto).

The second device 200 is an information processing apparatus that performs the processing regarding the input to the software application together with the first device 100. In one example, the second device 200 is a mobile device such as a smartphone operated by the user, various servers, an agent device that performs various processing for the user on behalf of the user to achieve various conveniences, that is, acting as an agent or secretary in a person-like manner, or the like. Moreover, the type of the second device 200 is not limited thereto. The second device 200 mediates the communication between the first device 100 and the third device 300. More specifically, the second device 200, when receiving the request information from the third device 300, analyzes the request information, generates speech information used for speech output from the first device 100, and transmits the speech information to the first device 100. In one example, the request information includes text information indicating contents of the request, and the second device 200 converts the text information into speech information using text-to-speech (TTS). Moreover, the way to generate speech information is not limited thereto. Then, the first device 100 performs the speech output and performs recognition and analysis of the gesture. The second device 200 receives a gesture analysis result from the first device 100. Then, the second device 200 recognizes contents of the input by the user on the basis of the gesture analysis result and transmits the recognized result as the input information to the third device 300.

The first device 100 is an information processing apparatus that performs the processing regarding the input to a software application, particularly performs speech output, gesture recognition, and gesture analysis, together with the second device 200. In one example, the first device 100 is a device worn on a user (e.g., such as wearable devices of an earphone type, glasses type, or the like, headphones, or head-mounted displays), an agent device equipped with a person recognition function with a camera, or the like (e.g., such as a smart speaker). Moreover, the type of the first device 100 is not limited thereto. The first device 100 functions as the “information processing apparatus according to the present disclosure” described above. In other words, the first device 100 is capable of obtaining information regarding requests from two or more software applications. Thus, the first device 100 recognizes a gesture made by the user who hears speech corresponding to the request and analyzes the gesture on the basis of an algorithm that is uniformly defined for two or more software applications, so calculates information regarding the user input to the request as the analysis result. Then, the first device 100 transmits the analysis result to the second device 200.

In this regards, the expression “information regarding requests from two or more software applications” can refer to information generated on the basis of the request information from the software application executed by each of the two or more third devices 300 (the speech information generated by the second device 200 on the basis of the request information in the present embodiment) or can refer to the request information itself. In addition, the expression “capable of obtaining information regarding requests from two or more software applications” does not mean that the number of software applications currently obtaining information regarding requests is necessary to be two or more. It is sufficient that the number of software applications capable of obtaining the information regarding the requests is two or more. In addition, the term “algorithm” refers to a way or logic used in the processing of analyzing a gesture and calculating information regarding the user input. In addition, the term “gesture” refers to all motions of the user's body. In one example, motions such as shaking the head up, down, left, or right, raising an arm, bending a finger are all included in the gesture. The first device 100 recognizes a gesture made by a user on the basis of sensor information acquired by, in one example, various sensors (e.g., such as an inertial sensor including acceleration sensors, gyro sensors, etc.) included in the first device 100 itself. Furthermore, the expression “information regarding the user input” can be not only the information indicating the user input but also any information regarding the user input. In one example, the information regarding the user input is not only information indicating the user input (e.g., such as information indicating the input “select option B” in response to a request “Please select one from options A, B, and C”) but also information corresponding to the recognized gesture or the like (e.g., such as the number “2” corresponding to the gesture “shake the head up and down”). Moreover, the contents of the information regarding the user input are not limited thereto.

A specific example of the processing performed by the first device 100, second device 200, and third device 300 mentioned above is described. Examples of a typical request made from the third device 300 to the second device 200 include a request for selecting one from the list of text that the third device 300 uses as an argument. The second device 200 interprets the text, adds an appropriate alert sound to the user, a directive wording, or the like, and then provides the speech information generated using TTS for the first device 100. The speech information to be provided includes information giving an instruction to read in order for the previous list one by one. The first device 100 outputs the input-related information by recognizing the gesture made by the user when reading the list. Then, the second device 200 recognizes which item in the list the user makes the gesture to recognize the item selected from the list on the basis of the input-related information provided from the first device 100 as a result of the gesture recognition and the contents of the speech output at that time. The second device 200 returns the recognition result to the third device 300 as the request source, so the third device 300 is capable of executing the processing relating to the software application on the basis of the return value.

The network 400 is a network that connects between the devices mentioned above using a predetermined communication. Moreover, the communication scheme, channel type, or the like employed in the network 400 is not limited to a particular one. In one example, the network 400 can be implemented as a leased line network such as an Internet protocol-virtual private network (IP-VPN). In addition, the network 400 can be implemented as a public network such as the Internet, telephone networks, and satellite communication networks, various local area networks (LANs) including Ethernet (registered trademark), wide area network (WAN), or the like. Furthermore, the network 400 can be implemented as a wireless communication network such as Wi-Fi (registered trademark) or Bluetooth (registered trademark). In addition, the communication schemes and channel types of the network 400a and the network 400b can be different from each other.

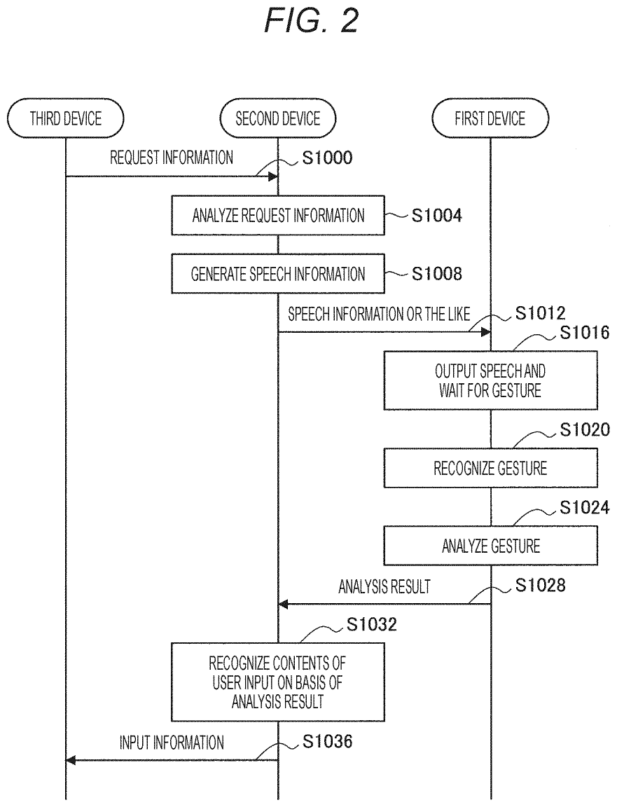

An example of the procedure of processing performed by each of the devices mentioned above is now described with reference to FIG. 2. FIG. 2 is a sequence diagram showing an example of a procedure of processing regarding input that is performed by each device according to the present embodiment.

In step S1000, one of the two or more third devices 300 transmits request information used to request the user input to the second device 200. Then, the second device 200 analyzes the request information in step S1004 and performs the processing such as TTS using the text information included in the request information to generate speech information in step S1008. The second device 200 transmits the speech information or the like to the first device 100 in step S1012. More specifically, the second device 200 transmits the speech information and information indicating a component (e.g., such as a radio button or a checkbox) to be input to the first device 100. Moreover, the information transmitted together with the speech information from the second device 200 is not limited to the information indicating the component.

In step S1016, the first device 100 outputs speech using the speech information and waits for a gesture to be made by the user. In step S1020, the first device 100 recognizes the gesture made by the user, in one example, on the basis of the sensor information acquired by the various sensors included in the first device 100. In step S1024, the first device 100 analyzes the gesture to calculate the information regarding the user input as an analysis result. In one example, the first device 100 grasps the information corresponding to each gesture for each component to be input. Then, the first device 100 calculates, as the analysis result, information corresponding to the recognized gesture (e.g., such as the number “2” corresponding to the gesture “shake the head up and down”) for the component to be input, which is given in notification from the second device 200. In step S1028, the first device 100 transmits the analysis result to the second device 200.

In step S1032, the second device 200 recognizes the contents of the user input on the basis of the analysis result. In one example, in a case where the information corresponding to the gesture provided as the analysis result is the number “2”, the second device 200 recognizes the contents indicated by the number “2”. Specifically, the second device 200 recognizes selecting one or two or more items from two or more items, changing the state of one or two or more items, or the like as the contents indicated by the number “2”. Alternatively, in a case where the second device 200 makes a request in advance to select one from continuous values and the first device 100 returns 2.0, the second device 200 performs an operation corresponding to the selection of the continuous value of 2.0. In step S1036, the second device 200 transmits the contents of the user input to the third device 300 as input information.

The series of processing steps described above makes it possible for the third device 300 to recognize the contents of the user input and to execute the processing relating to the software application on the basis of the contents of the input. In addition, the first device 100 analyzes the gesture using an algorithm that is uniformly defined for two or more software applications, so the user is able to understand the common rule in the algorithm, thereby easily performing the input to the two or more software applications. In addition, as shown in FIG. 2, defining the contents of the information transmitted and received between the respective devices allows the input by the user to be achieved without depending on the type of each device. In one example, the third device 300 is capable of receiving the input from the user regardless of the types of the first device 100 and the second device 200.

The above description is given of the exemplary configuration of the information processing system and the processing example in each device, according to the present embodiment. Moreover, the configuration described with reference to FIG. 1 and the processing described with reference to FIG. 2 are merely examples. The configuration of the information processing system and the processing in each device according to the present embodiment are not limited thereto. In one example, the function of each device can be implemented in different devices. In one example, the functions of the first device 100 can be implemented in the entirety or a part thereof by the second device 200, and conversely, the functions of the second device 200 can be implemented in the entirety or a part thereof by the first device 100. The configuration of the information processing system and the processing of each device according to the present embodiment are modifiable flexibly depending on specifications or operations.

<3. Functional Configuration Example of Device>

The configuration example of the information processing system and the processing example in each device according to the present embodiment are described above. A functional configuration example of each device according to the present embodiment is now described.

(3.1. Functional configuration example of first device 100)

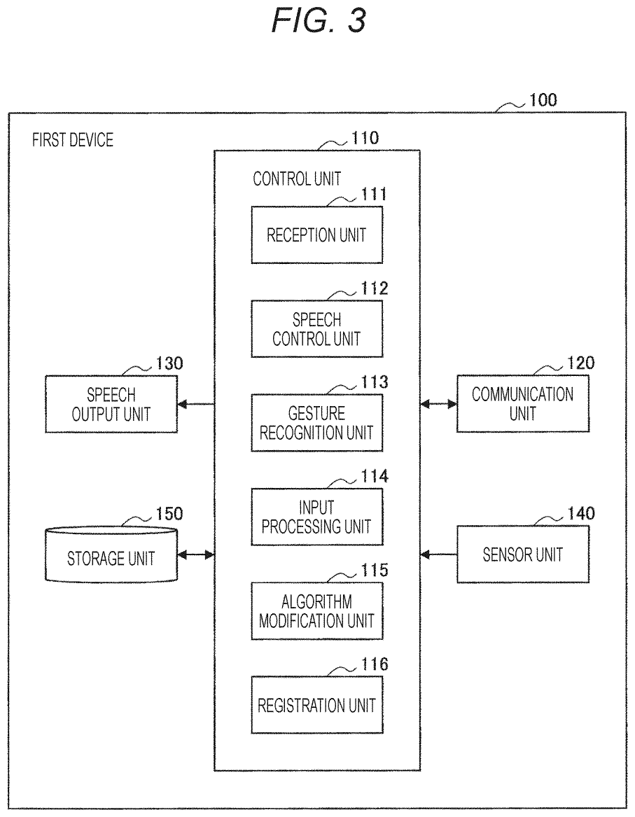

An example of the functional configuration of the first device 100 according to the present embodiment is now described with reference to FIG. 3. FIG. 3 is a block diagram illustrating an example of the functional configuration of the first device 100 according to the present embodiment. As illustrated in FIG. 3, the first device 100 includes a control unit 110, a communication unit 120, a speech output unit 130, a sensor unit 140, and a storage unit 150. In addition, the control unit 110 includes a reception unit 111, a speech control unit 112, a gesture recognition unit 113, an input processing unit 114, an algorithm modification unit 115, and a registration unit 116.

The control unit 110 has a functional configuration that centrally controls the overall processing performed by the first device 100. In one example, the control unit 110 is capable of generating control information and providing the control information for each functional configuration, to control activation, deactivation, or the like of each functional configuration. Moreover, the function of the control unit 110 is not limited to a particular one. In one example, the control unit 110 can control processing typically performed in various servers, general-purpose computers, personal computers (PCs), tablet PCs, or the like (e.g., such as processing relating to an operating system (OS)).

The reception unit 111 has a functional configuration capable of obtaining information regarding requests from two or more software applications. More specifically, the reception unit 111 has a functional configuration capable of obtaining request-related information (such as speech information) from the second device 200 (an external device) that obtains requests from two or more software applications.

The speech control unit 112 is a functional configuration that controls the output of speech by the speech output unit 130. More specifically, the speech control unit 112 controls the output of speech by the speech output unit 130 on the basis of the speech information provided from the second device 200 to urge the user to perform the input to a request from the software application. Then, in a case where the user who hears the speech makes a gesture for the input, the speech control unit 112 causes the speech output unit 130 to output speech used to check the input contents (or used to report the input contents).

Moreover, the speech control unit 112 can also appropriately change the mode of speech output, instead of controlling the speech output using the speech information provided from the second device 200 without any modification. In one example, the speech control unit 112 can appropriately change the speech output mode on the basis of a gesture or the like made by the user. More specifically, there may be a case where the user is presented with the request-related information (e.g., two or more optional items) using the gesture “shake the head once to right”. In this case, in one example, if the user makes a gesture “shake the head once to right” at a speed equal to or higher than a predetermined speed or makes another gesture (e.g., “shake the head once to left”, or the like), the speech control unit 112 can cause the speech to be output quickly or the speech output of each item to be skipped. Thus, the speech control unit 112 can implement the speech output in a manner desired by the user. A specific example of the control of the speech output by the speech control unit 112 will be described later in detail.

The gesture recognition unit 113 has a functional configuration that recognizes a gesture made by the user who hears speech corresponding to a request. In one example, the gesture recognition unit 113 recognizes the gesture by calculating the position and attitude of the first device 100 on the basis of the sensor information acquired by an inertial sensor or the like included in the sensor unit 140.

Moreover, the sensor type used by the gesture recognition unit 113 for the gesture recognition processing is not limited to a particular one. In one example, the gesture recognition unit 113 can recognize the gesture by using an image sensor (i.e., a camera) and analyzing the captured image that is output by the image sensor. In addition, the gesture recognition unit 113 can recognize the gesture on the basis of the sensor information acquired by various sensors being provided other than the sensor unit 140. In one example, there may be a case where a plurality of external devices provided with the inertial sensor is attached to a joint part or the like of the user's body. In this case, the gesture recognition unit 113 can recognize the gesture by calculating the position and attitude of each mounting portion of the external devices on the basis of the sensor information acquired by the inertial sensor. In addition, the gesture recognition unit 113 can recognize the gesture by calculating skeleton information (e.g., including information regarding body parts and information regarding bones that are line segments connecting the parts) on the basis of the position and attitude of each mounting portion of the external device. In addition, the gesture recognition unit 113 can distinguish the gestures from each other depending on the speed at which the gesture is performed, the orientation or height of each portion in the gesture, the portion at which the gesture is performed, or the like. In one example, there may be a case where the gesture is made faster or slower than a predetermined value, a case where the orientation or height of the limbs in the gesture is different, a case where the gesture is performed on the left limb or performed on the right limb, or the like. In each case, the gesture recognition unit 113 can recognize the gestures as different ones from each other.

The input processing unit 114 is a functional configuration that analyzes a gesture on the basis of an algorithm that is uniformly defined for two or more software applications to calculate information regarding the user input in response to a request from a software application. In one example, the input processing unit 114 calculates, as the analysis result, information corresponding to the recognized gesture (e.g., such as the number “2” corresponding to the gesture “shake the head up and down”). Moreover, as described above, the contents of the information regarding the user input are not limited thereto. Then, the input processing unit 114 provides the second device 200 (an external device) with the information regarding the user input as the analysis result.

Moreover, the input operation performed by the user is not necessarily to be the gesture alone. In one example, the user can perform input using a combination of the gesture and the input with various input devices (e.g., such as buttons, various sensors, microphones, mice, keyboards, touch panels, switches, or levers). In one example, the user can perform the input by making a gesture by pressing or clicking a button, making a gesture by holding the hand over the proximity sensor, or making a gesture by uttering some speech to the microphone. In this case, the input processing unit 114 analyzes not only the gesture but also the combination of the gesture and the input operation to the input device, on the basis of the algorithm that is uniformly defined for two or more software applications, thereby calculating the information regarding the user input.

The algorithm modification unit 115 has a functional configuration for modifying the algorithm used for the processing relating to the input. The algorithm modification unit 115 allows the user to modify the algorithm to an algorithm desired by the user. Details thereof will be described later.

The registration unit 116 is a functional configuration that recognizes a gesture made by the user and newly registers it as a gesture to be used for the processing for calculating the information regarding the user input in the input processing unit 114. The registration unit 116 allows the user to register newly a desirable gesture as a gesture used for the input. Details thereof will be described later.

The communication unit 120 has a functional configuration that communicates with an external device. In one example, the communication unit 120 receives the speech information or the like from the second device 200. Then, in the case where the input processing unit 114 calculates the information regarding the input, the communication unit 120 transmits the calculated information regarding the input to the second device 200 as the analysis result. Moreover, the information to be communicated through the communication unit 120 and the communication mode of the communication unit 120 are not limited thereto.

The speech output unit 130 is a functional configuration that outputs speech under the control of the speech control unit 112. In one example, the speech output unit 130 includes a speech output mechanism such as a speaker or a broadband actuator (an actuator capable of outputting vibration in the audible range) and outputs speech corresponding to a request from a software application under the control of the speech control unit 112. Moreover, the type, way, or the like of the speech output mechanism provided in the speech output unit 130 is not limited to a particular one.

The sensor unit 140 is a functional configuration including a sensor used for the gesture recognition processing performed by the gesture recognition unit 113. The sensor unit 140 includes, in one example, an inertial sensor or the like such as an acceleration sensor or a gyro sensor as described above, but the type of a sensor included in the sensor unit 140 is not necessarily limited thereto.

The storage unit 150 is configured to store various types of information. In one example, the storage unit 150 stores the information regarding the request (e.g., such as speech information) from the software application that is obtained by the reception unit 111, the analysis result of the input processing unit 114, or the like. In addition, the storage unit 150 stores a program (such as a program in which an algorithm uniformly defined for two or more software applications is incorporated), a parameter, or the like used for the processing in the first device 100. Moreover, the information to be stored in the storage unit 150 is not limited thereto.

The above description is given of the example of the functional configuration of the first device 100. Moreover, the functional configuration described above with reference to FIG. 3 is merely an example, and the functional configuration of the first device 100 is not limited to this example. More specifically, the first device 100 may not necessarily include some of the functional configurations shown in FIG. 3 or can have a functional configuration not shown in FIG. 3. In addition, the functional configuration illustrated in FIG. 3 can be included in an external device, and the first device 100 can implement each function described above by communicating and cooperating with the external device. In one example, the speech can be output by controlling a speaker or the like having a configuration in which the speech output unit 130 is not included in the first device 100 and the speech control unit 112 is provided in the external device.

(3.2. Functional configuration example of second device 200)

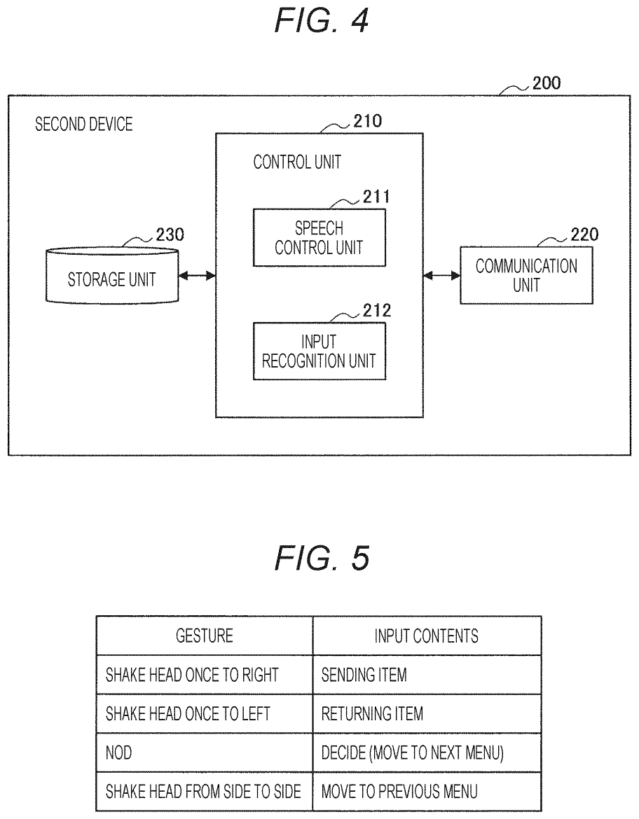

Next, an example of the functional configuration of the second device 200 according to the present embodiment is now described with reference to FIG. 4. FIG. 4 is a block diagram illustrating an example of the functional configuration of the second device 200 according to the present embodiment. As illustrated in FIG. 4, the second device 200 includes a control unit 210, a communication unit 220, and a storage unit 230. The control unit 210 includes a speech control unit 211, and an input recognition unit 212.

The control unit 210 has a functional configuration that centrally controls the overall processing performed by the second device 200. In one example, the control unit 210 is capable of generating control information and providing the control information for each functional configuration, to control activation, deactivation, or the like of each functional configuration. Moreover, the function of the control unit 210 is not limited to a particular one. In one example, the control unit 210 can control processing typically performed in various servers, general-purpose computers, PCs, tablet PCs, or the like (e.g., such as processing relating to an OS).

The speech control unit 211 has a functional configuration that controls the output of speech performed by the first device 100. In one example, the request information provided from the third device 300 includes text information indicating the request, and the speech control unit 211 converts the text information into speech information using TTS or the like. Then, the speech control unit 211 controls the speech output performed by the first device 100 by transmitting the speech information to the first device 100 via the communication unit 220.

The input recognition unit 212 is a functional configuration that recognizes the contents of the input made by the user on the basis of the analysis result of the gesture, which is provided from the first device 100. In one example, in a case where the analysis result of the gesture is information corresponding to the gesture (e.g., such as the number “2” corresponding to the gesture of “shake the head up and down”), the input recognition unit 212 recognizes the contents of the information. Specifically, the input recognition unit 212 recognizes that one or two or more items are selected from two or more items, that the states of one or two or more items are changed, or the like, as the contents of the information corresponding to the gesture. Alternatively, in a case where the second device 200 makes a request in advance to select one from the continuous values and the first device 100 returns 2.0, the input recognition unit 212 performs an operation corresponding to the selection of the continuous value of 2.0. Moreover, the contents of the input recognized by the input recognition unit 212 are not limited thereto. Then, the input recognition unit 212 outputs the contents of the input made by the user as input information.

The communication unit 220 has a functional configuration that communicates with an external device. In one example, the communication unit 220 receives the request information from the third device 300 and transmits the speech information generated on the basis of the request information to the first device 100. In addition, when the first device 100 analyzes the gesture, the communication unit 220 receives the analysis result from the first device 100 and transmits the input information that is output on the basis of the analysis result to the third device 300. Moreover, the information to be communicated through the communication unit 220 and the communication mode of the communication unit 220 are not limited thereto.

The storage unit 230 is configured to store various types of information. In one example, the storage unit 230 stores the request information provided from the third device 300, the analysis result provided from the first device 100, the input information that is output from the input recognition unit 212, or the like. In addition, the storage unit 230 also stores a program, a parameter, or the like used for the processing in the second device 200. Moreover, the information stored in the storage unit 230 is not limited thereto.

The above description is given of the example of the functional configuration of the second device 200. Moreover, the functional configuration described above with reference to FIG. 4 is merely an example, and the functional configuration of the second device 200 is not limited to this example. More specifically, the second device 200 may not necessarily include some of the functional configurations shown in FIG. 4 or can have a functional configuration not shown in FIG. 4. In addition, the functional configuration illustrated in FIG. 4 can be included in an external device, and the second device 200 can implement each function described above by communicating and cooperating with the external device.

In this regard, the third device 300 has the functional configuration that generates the request information requesting the input by the user and transmits the request information to the second device 200 and has the functional configuration that executes processing relating to a software application on the basis of the input information provided from the second device 200. Thus, the description of such functional configurations is omitted.

<4. Example of Input>

The example of the functional configuration of each device according to the present embodiment is described above. A specific example of the input implemented by the present embodiment is now described.

(4.1. Input 1 relating to selection of item)

With reference to FIGS. 5 to 7, a specific example of input relating to selecting one item from two or more items (or input relating to changing the state of one item) is now described. More specifically, a specific example of the input in a case where one item is selected from two or more items by the user and is decided at the same time as the selection (or input in the case where the state of one item is changed by the user and is decided at the same time as the change) is described.

FIG. 5 is a table showing an example of the relationship between a gesture and input contents. More specifically, it is assumed that “shake the head once to right” corresponds to “sending item”, “shake the head once to left” corresponds to “returning item”, “nod” corresponds to “decide” (move to next menu), and “shake the head from side to side” corresponds to “move to previous menu”. In a case where the user performs gestures shown in FIG. 5, the cooperation between the first device 100 and the second device 200 with each other makes it possible for the input recognition unit 212 of the second device 200 to recognize the input contents corresponding to the gestures. Moreover, the relationship between the gesture and the input contents is not limited to the example of FIG. 5.

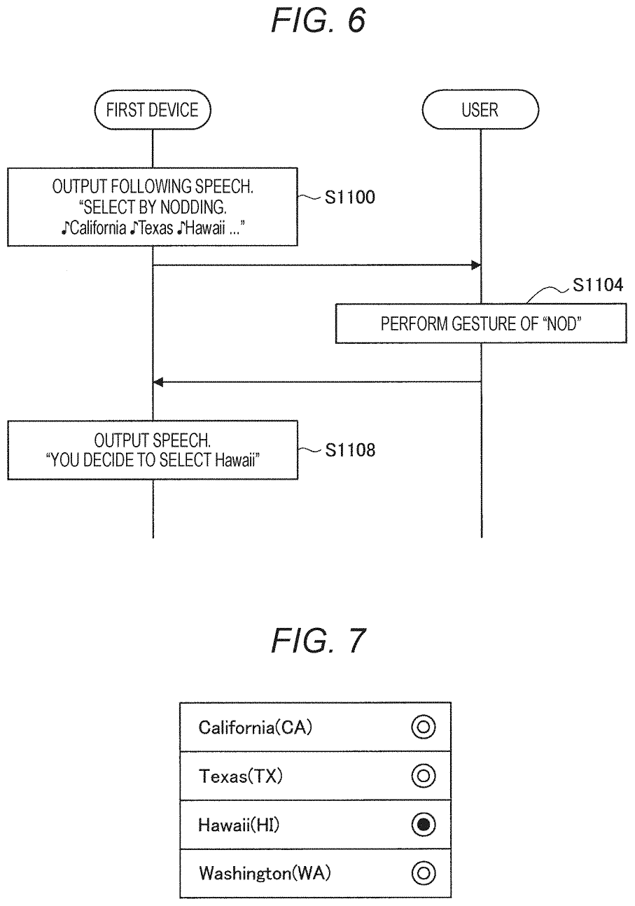

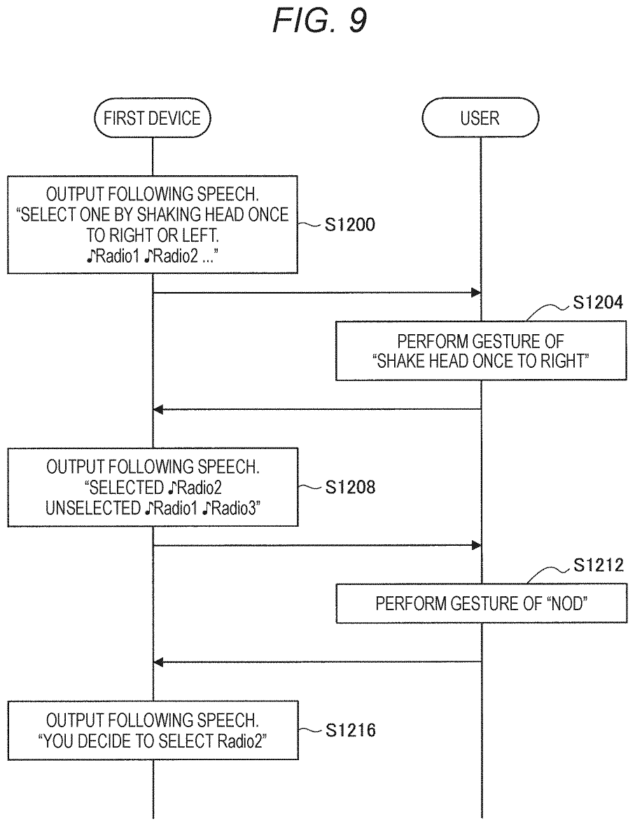

FIG. 6 is a sequence diagram showing an example of the procedure of processing in the first device 100 and the operation of the user. Moreover, FIG. 6 is a diagram shown to mainly describe the interaction between the first device 100 and the user, and so note that the processing in the second device 200 and the processing in the third device 300 are omitted (FIGS. 9, 12, and 15 are described later in similar way).

In step S1100 of FIG. 6, it is assumed that the speech control unit 112 of the first device 100 causes the speech output unit 130 to output the speech of “Select by nodding [symbol] California [symbol] Texas [symbol] Hawaii . . . ” (where “ [symbol] ” indicates the output of sound effect). Moreover, in a case where the user recognizes that the gesture of “nod” corresponds to “decide (move to next menu)”, the speech of “by nodding” can be omitted. In step S1104, the user performs the gesture of “nod” immediately after “Hawaii”.

Then, the gesture recognition unit 113 of the first device 100 recognizes the gesture, the input processing unit 114 analyzes the gesture and provides the analysis result for the second device 200, and the input recognition unit 212 of the second device 200 recognizes the input contents on the basis of the analysis result. Then, the cooperation between the speech control unit 211 of the second device 200 and the speech control unit 112 of the first device 100 with each other causes the speech output unit 130 of the first device 100 to output the speech used to check the input contents. In one example, the speech control unit 211 of the second device 200 generates speech information used to check the input contents, and the speech control unit 112 of the first device 100 controls the speech output unit 130 using the speech information so that the speech output unit 130 outputs speech used to report the input contents. In one example, in step S1108, the speech output unit 130 of the first device 100 outputs the speech of “You decide to select Hawaii”.

FIG. 7 is an image diagram of a GUI after input is performed by the series of processing steps shown in FIG. 6 in a case of being provided with the GUI for input. The user performs the gesture of “nod” immediately after “Hawaii” in step S1104 of FIG. 6, and so the item “Hawaii” is selected from two or more items as shown in FIG. 7 and is decided at the same time as the selection. Moreover, a GUI used for the input as shown in FIG. 7 may not be necessarily provided. In addition, in a case where, for example, the screen of the GUI is erased during performing the input using the GUI, the input method can be switched to the method using the speech output and the gesture as described above. On the contrary, in a case where, for example, the screen of the GUI is started during performing the input using the speech output and the gesture, the input method can be switched to the method using the GUI.

The above description is given of the specific example of the input in the case where the user selects one item from two or more items and performs decision at the same time as the selection (or the input in the case where the user changes the state of one item and decides at the same time as the change).

In this regard, the first device 100 can specify the direction in which the body part of the user moves in the gesture upon selecting each item. In one example, the first device 100 outputs speech such as “California is in the right direction” or “Texas is in the left direction”, and so can specify the direction in which the body part of the user moves in the gesture (e.g., the direction of shaking the head in the gesture of shaking the head). In the example of FIG. 6 described above, a blank period having a predetermined length (e.g., a blank period of approximately 1 to 3 seconds, and hereinafter the period for input such as the blank period is referred to as an “input period”) is provided after reading each item. The user is necessary to perform the input by making a gesture within the input period. On the other hand, the first device 100 is capable of lengthening the input period by specifying the direction in which the body part moves in the gesture. More specifically, there may be a situation where, after outputting the speech relating to the input of one item (e.g., “California is in the right direction”), the speech relating to the input of another item (e.g., “Texas is in the left direction”) is output. Even in this case, the user is able to select the item by making a gesture in the direction corresponding to the desired item as long as the directions specified by each speech do not overlap (e.g., capable of selecting “California” by making the gesture of shaking the head in the right direction). In other words, the first device 100 is capable of lengthening the input period of each item as the number of specified directions increases.

Moreover, the way to specify the direction in the gesture is not limited only to the way to clearly indicate the direction by speech such as “in the left direction”. In one example, in a case where the first device 100 is a headphone, the first device 100 can output the speech of each item from the ear side in the direction specified in the gesture. More specifically, an item in which speech is output from the right ear side of the headphone can be selected by performing a predetermined gesture in the right direction (e.g., a gesture of shaking the head in the right direction). In addition, an item in which speech is output from the left ear side can be selected by performing a predetermined gesture in the left direction. In addition, the first device 100 can output each item as a sound image and localize the sound image in the direction specified in the gesture.

(4.2. Input 2 relating to selection of item)

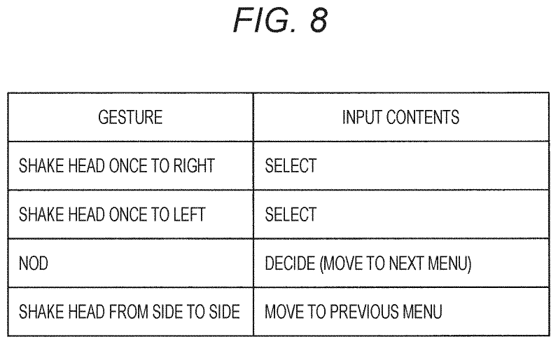

With reference to FIGS. 8 to 10, a specific example of input relating to selecting one item from two or more items (or input relating to changing the state of one item) is now described. More specifically, a specific example of the input in a case where one item is selected from two or more items by the user and the selection is decided by another input (or input in the case where the state of one item is changed by the user and the change is decided by another input) is described.

FIG. 8 is a table showing an example of the relationship between a gesture and input contents. More specifically, it is assumed that “shake the head once to right” and “shake the head once to left” corresponds to “select”, “nod” corresponds to “decide” (move to next menu), and “shake the head from side to side” corresponds to “move to previous menu”. Moreover, the relationship between the gesture and the input contents is not limited to the example of FIG. 8.

FIG. 9 is a sequence diagram showing an example of a procedure of processing by a first device 100 and a user's motion. In step S1200, it is assumed that the speech control unit 112 of the first device 100 controls the speech output unit 130 so that the speech output unit 130 outputs the speech of “Select one by shaking the head once to right or left. [symbol] Radio1 [symbol] Radio2 . . . ”. Moreover, in a case where the user recognizes that the gesture “shake the head once to right” or the gesture “shake the head once to left” corresponds to “select”, the part of the speech “by shaking the head once to right or left” can be omitted. In step S1204, the user performs the gesture “shake the head once to right” immediately after “Radio2”.

Then, the input recognition unit 212 of the second device 200 recognizes the input contents, and the speech control unit 112 of the first device 100 causes the speech output unit 130 to output the speech used to check the input contents. In this case, the speech control unit 112 controls the output of speech depending on whether or not an item is selected (or the state of the item). In one example, the speech control unit 112 causes the speech output unit 130 to collectively output, as speech, the selected items or unselected items (or causes the speech output unit 130 to output collectively the items having the same state as speech). In one example, in step S1208, the speech control unit 112 controls the speech output unit 130 so that the speech output unit 130 outputs the speech “Selected [symbol] Radio2 unselected [symbol] Radio1 [symbol] Radio3”. In this regard, there may be a case, for example, where facts of whether or not the selection is performed for each item are sequentially output by speech such as “Unselected [symbol] Radio1 Selected [symbol] Radio2 Unselected [symbol] Radio3”. In this case, the user is confused and so it is difficult for the user to recognize whether or not each item is selected, and the time taken for the speech output is longer. On the other hand, in a case where selected items or unselected items (or items having the same state) are output as a batch as described above, the user is able to recognize whether or not the selection is performed for each item (or state for each item) without confusion and the time taken for the speech output is shorter. Moreover, the way to control the speech output depending on whether or not an item is selected (or the state of an item) is not limited to the above example. In one example, in the case where the first device 100 is a headphone, the speech control unit 112 can control whether the speech is output from the right ear side or the left ear side depending on whether or not an item is selected (or the state of an item). In addition, the speech control unit 112 can output each item as a sound image and can control the position where the sound image is localized depending on whether or not the item is selected (or the state of the item). In addition, the speech control unit 112 can control the sound quality depending on whether or not an item is selected (or the state of the item).

In step S1212, the user performs a gesture “nod”. Then, the input recognition unit 212 of the second device 200 recognizes the input contents, and the speech control unit 112 of the first device 100 causes the speech output unit 130 to output the speech used to report the input contents. In one example, in step S1216, the speech control unit 112 of the first device 100 controls the speech output unit 130 so that the speech output unit 130 outputs the speech “You decide to select Radio2”.

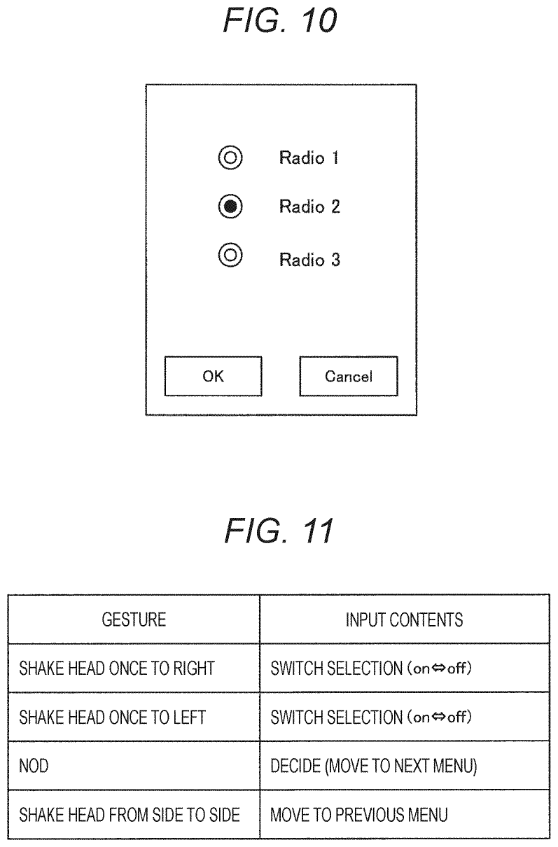

FIG. 10 is an image diagram of a GUI after input is performed by the series of processing steps shown in FIG. 9 in a case of being provided with the GUI for input. The user makes the gesture “Shake the head once to right” immediately after “Radio2” in step S1204 of FIG. 9 and performs the gesture “nod” in step S1212. Thus, the item “Radio2” is selected from two or more items and the selection is decided as illustrated in FIG. 10.

The above description is given of the specific example of the input in the case where the user selects one item from two or more items and the selection is decided by another input (or the user changes the state of one item and the change is decided by another input). This is particularly useful in a case, for example, where more careful work is necessary, such as a case where the user selects and decides a message or email destination. Moreover, also in this input example, the first device 100 can specify the direction in which the body part of the user moves in the gesture.

(4.3. Input 3 Relating to Selection of Item)

With reference to FIGS. 11 to 13, a specific example of input relating to selecting two or more items from two or more items (or input relating to changing the state of two or more items) is now described. More specifically, a specific example of the input in a case where two or more items are selected from two or more items by the user and the selection is decided by another input (or input in the case where the state of two or more items is changed by the user and the change is decided by another input) is described.

FIG. 11 is a table showing an example of the relationship between a gesture and input contents. More specifically, it is assumed that “Shake the head once to right” and “Shake the head once to left” correspond to “Switch the selection” (in the example of FIG. 11, selected state is marked as “on” and unselected state is marked as “off”), “Nod” corresponds to “Decide (move to the next menu)”, and “Shake the head from side to side” corresponds to “Move to the previous menu”. Moreover, the relationship between the gesture and the input contents is not limited to the example of FIG. 11. In one example, “Shake the head once to right” can correspond to “Select”, and “Shake the head once to left” can correspond to “Unselected”.

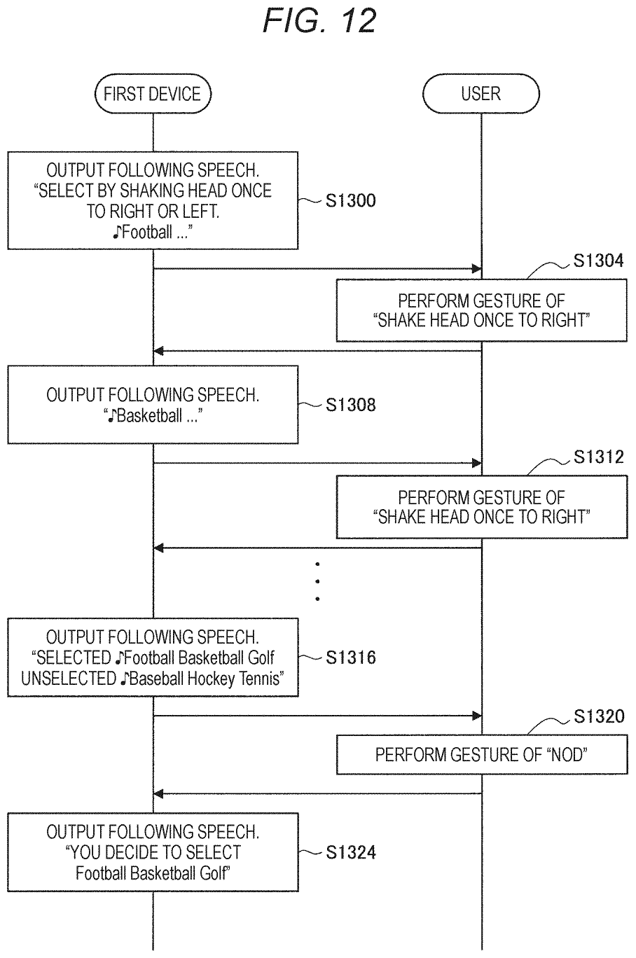

FIG. 12 is a sequence diagram showing an example of a procedure of processing by a first device 100 and a user's motion. In step S1300, it is assumed that the speech control unit 112 of the first device 100 controls the speech output unit 130 so that the speech output unit 130 outputs the speech of “Select one by shaking the head once to right or left. [symbol] Football . . . ”. Moreover, in a case where the user recognizes that the gesture “shake the head once to right” or the gesture “shake the head once to left” corresponds to “switch the selection”, the part of the speech “by shaking the head once to right or left” can be omitted. In step S1304, the user performs the gesture “shake the head once to right” immediately after “Football”.

In step S1308, the speech control unit 112 controls the speech output unit 130 so that the speech output unit 130 outputs the speech “ [symbol] Basketball . . . ”. In step S1312, the user performs the gesture “Shake the head once to right” immediately after “Basketball”. In this way, the speech is output for each item, and the gesture used to switch the selection is performed.

In a case where the speech output and the gesture execution are completed for all the items, the input recognition unit 212 of the second device 200 recognizes the input contents, and the speech control unit 112 of the first device 100 causes the speech output unit 130 to output the speech used to check the input contents. More specifically, the speech control unit 112 controls the output of speech depending on whether or not an item is selected (or the state of the item). In one example, in step S1316, the speech control unit 112 controls the speech output unit 130 so that the speech output unit 130 outputs the speech “Selected [symbol] Football Basketball Golf unselected [symbol] Baseball Hockey Tennis”. Thus, the user is able to recognize whether or not each item is selected (or the state of each item) without confusion, and the time taken for the speech output is shorter. Moreover, the way to control the speech output depending on whether or not an item is selected (or the state of an item) is not limited to the above example.

In step S1320, the user performs a gesture “nod”. Then, the input recognition unit 212 of the second device 200 recognizes the input contents, and the speech control unit 112 of the first device 100 causes the speech output unit 130 to output the speech used to report the input contents. In one example, in step S1324, the speech control unit 112 controls the speech output unit 130 so that the speech output unit 130 outputs the speech “You decide to select Football Basketball Golf”.

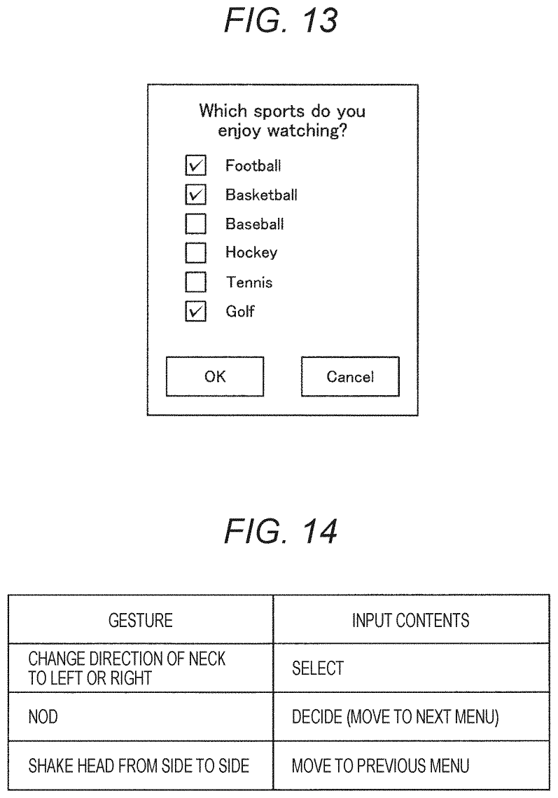

FIG. 13 is an image diagram of a GUI after input is performed by the series of processing steps shown in FIG. 12 in a case of being provided with the GUI for input. The user selects the item by making the gesture “Shake the head once to right” in step S1304 or S1312 or the like of FIG. 12, and the user makes the gesture “nod” to select the item in step S1320. As a result, three items “Football”, “Basketball”, and “Golf” are selected as shown in FIG. 13, and the selection is decided.

The above description is given of the specific example of the input in the case where the user selects two or more items from two or more items and the selection is decided by another input (or the user changes the state of two or more items and the change is decided by another input). Moreover, also in this input example, the first device 100 can specify the direction in which the body part of the user moves in the gesture.

(4.4. Input Regarding Selection of Value from Continuous Values)

With reference to FIGS. 14 to 16, a specific example of the input relating to selecting one value from continuous values (e.g., such as analog values including volume and the like) is now described. More specifically, a specific example of the input in a case where the user selects one value from continuous values and the selection is decided by another input is described.

FIG. 14 is a table showing an example of the relationship between a gesture and input contents. More specifically, it is assumed that “Change the direction of the neck to left or right” corresponds to “Select”. More specifically, there may be a case where the direction of the neck is associated with each value in the continuous values. In one example, in a case where the neck is facing a predetermined direction on the left side of the user (hereinafter, referred to as “first direction”), the minimum value of the continuous values is selected. In a case where the neck is facing a predetermined direction on the right side of the user (hereinafter, referred to as “second direction”), the maximum value of the continuous values is selected. In a case where the neck is facing the direction intermediate between the first direction and the second direction (hereinafter referred to as “third direction”), the intermediate value of the continuous values is selected (this means that the displacement of the body part of the user in the gesture corresponds to each value in the continuous values). In addition, it is assumed that “Nod” corresponds to “Decide (move to next menu)” and “Shake the head from side to side” corresponds to “Move to previous menu”. Moreover, the relationship between the gesture and the input contents is not limited to the example of FIG. 14.

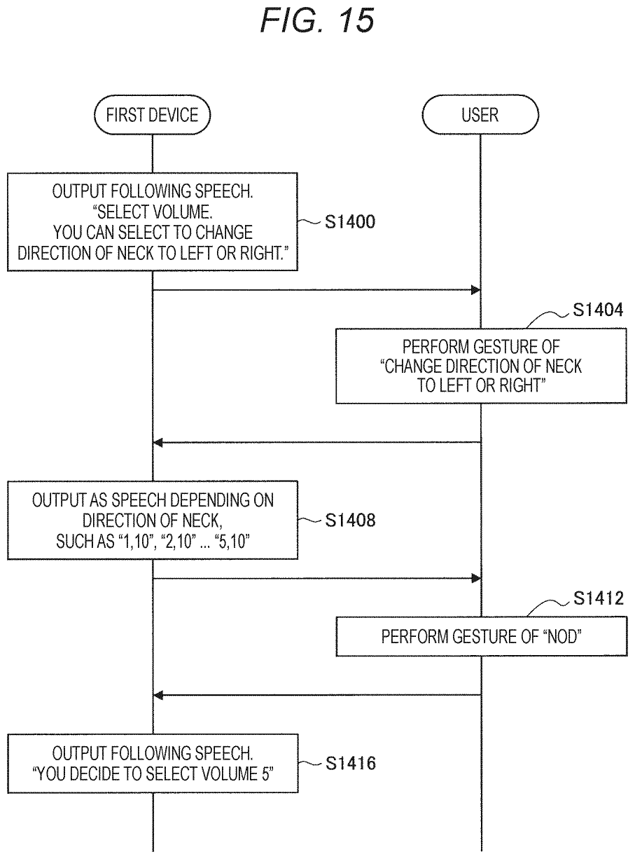

FIG. 15 is a sequence diagram showing an example of a procedure of processing by a first device 100 and a user's motion. In step S1400, it is assumed that the speech control unit 112 of the first device 100 controls the speech output unit 130 so that the speech output unit 130 outputs the speech “Select the volume. You can select to change the direction of the neck to left or right.”. Moreover, in a case where the user recognizes that the gesture “Change the direction of the neck to left or right” corresponds to “Select”, the speech of the part of “You can select to change the direction of the neck to left or right.” can be omitted. In step S1404, the user performs the gesture “Change the direction of the neck to left or right”.

Then, the input recognition unit 212 of the second device 200 recognizes the input contents, and the speech control unit 112 of the first device 100 causes the speech output unit 130 to output the speech used to check the input contents. In this case, the speech control unit 112 can control the output of speech depending on the value selected in the continuous values and the maximum value or the minimum value in the continuous values so that the user can appropriately recognize the magnitude of the selected value in the entire continuous value. In one example, in a case where the maximum value of selectable volume (continuous value) is 10, the speech control unit 112 can perform so that the selected value and the maximum value of the continuous values can be sequentially output as speech depending on the direction of the user's neck, such as “1,10”, “2,10” . . . “5,10”, in step S1408. Accordingly, even in a case where no GUI is provided (or a case where the GUI is incapable of being used), the user is able to appropriately recognize the magnitude of the selected value in the entire continuous value.

In step S1412, the user makes a gesture “nod” in a state where the user selects the volume 5 as a desired value. Then, the input recognition unit 212 of the second device 200 recognizes the input contents, and the speech control unit 112 of the first device 100 causes the speech output unit 130 to output the speech used to report the input contents. In one example, in step S1416, the speech control unit 112 controls the speech output unit 130 so that the speech output unit 130 outputs the speech of “You decide to select the volume 5”.

Moreover, in FIG. 15, the case where the continuous value is “volume” is described as an example, but the continuous value is understandably not limited thereto. In one example, in a case where the continuous value is a “musical interval”, the speech control unit 112 can cause the selected value and the maximum value of the selectable musical intervals to be sequentially output as speech such as “Do-So”, “Mi-So”, or “So-So” depending on the direction of the user's neck. In addition, the way to control the speech output depending on the selected value in the continuous value and the maximum value or the minimum value in the continuous value is not limited to the example of FIG. 15. In one example, in the case where the continuous value is “volume”, the speech control unit 112 can cause the predetermined sound effects to be output by speech in the order of the selected volume and the maximum volume value. In addition, in the case where the continuous value is a “musical interval”, the speech control unit 112 can cause the predetermined sound effects to be output by speech in the order of the selected musical interval and the maximum value of the musical interval.

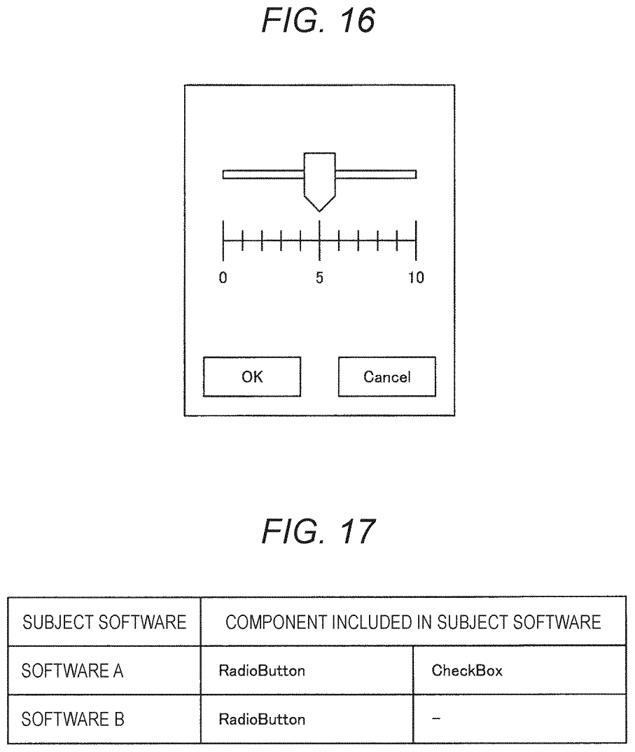

FIG. 16 is an image diagram of a GUI after input is performed by the series of processing steps shown in FIG. 15 in a case of being provided with the GUI for input. In step S1404 of FIG. 15, the user selects the volume 5 by performing the gesture “Change the direction of the neck to left or right”, and in step S1412, the user decides the selection by performing the gesture “Nod”. As a result, the volume 5 is selected as shown in FIG. 16, and the selection is decided. The above description is given of the specific example of the input in the case where the user selects one value from the continuous values and the selection is decided by another input.

(4.5. Other Types of Input)

The relationship between the gesture and the input contents is defined in advance for the input described above, in one example, as shown in FIG. 5. However, there are cases where the input by a gesture that is not defined in advance is necessary. In one example, in a case where a new function is added to the software application, the input by a gesture that is not defined in advance can be necessary for the new function.

In this case, the third device 300 that executes the software application can include information used to specify a gesture for the input in the request information. Then, in one example, in a case where the contents of a request (a request for checking whether to purchase an airline ticket to Hawaii) is output by speech, such as “Nod twice when purchasing an airline ticket to Hawaii”, the first device 100 can specify the gesture for the input (nod twice). Then, the first device 100 determines whether or not the specified gesture is performed by the user and provides the result for the second device 200, thereby implementing the input by a gesture that is not defined in advance. Moreover, in this case, the information used for the recognition processing of the specified gesture (e.g., such as the pattern of the sensor information regarding the gesture) can be separately provided for the first device 100.

<5. Modification or the Like of Algorithm>

The above description is given of the specific example of the input implemented by the present embodiment. The modification of the algorithm or the like used for the processing regarding the input is now described. As described above, in the present embodiment, the processing regarding the input is performed on the basis of the algorithm that is uniformly defined for two or more software applications, but the algorithm can be appropriately modified by the user.

In one example, as shown in FIG. 17, it is assumed that there are given software applications A and B. In addition, the software application A includes “RadioButton” and “CheckBox” as components, and the software application B includes “RadioButton” as a component. In other words, “RadioButton” is a component common to the software applications A and B. In this case, the user is able to collectively modify the algorithms for the component “RadioButton” common to the software applications A and B.

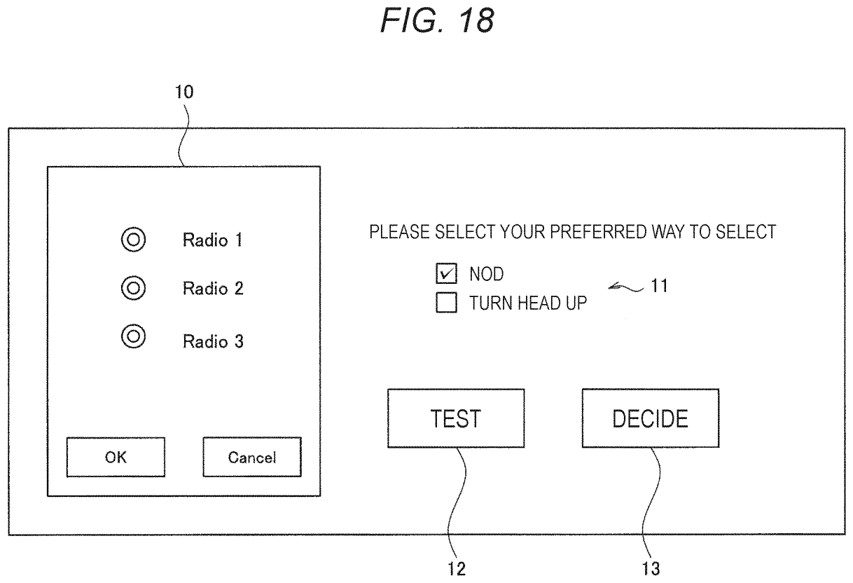

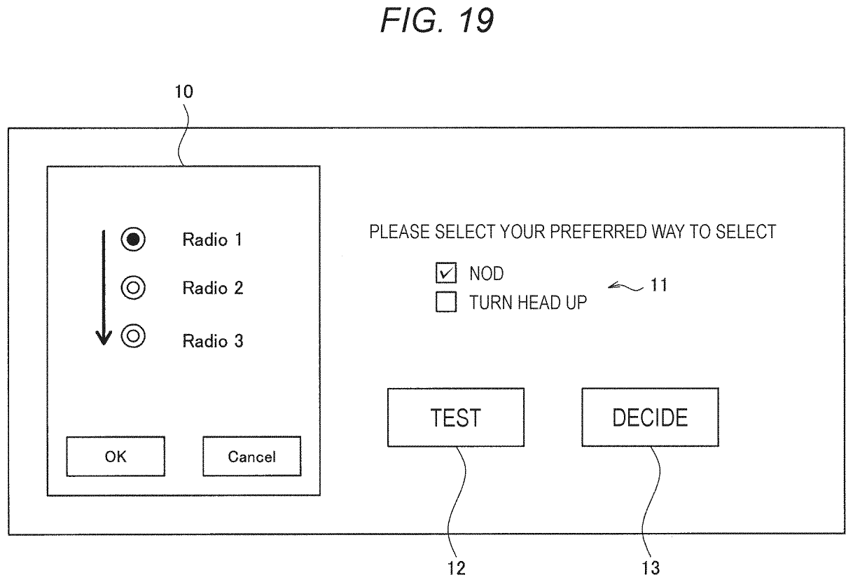

FIGS. 18 and 19 are diagrams showing a specific example of the GUI used for modifying the algorithm for “RadioButton”. The user is able to modify the algorithm while using the GUI by using various information processing apparatuses such as a smartphone (hereinafter, various information processing apparatuses such as smartphones are referred to as a “device for changing settings”).

FIG. 18 shows a GUI 10 corresponding to “RadioButton”, a checkbox 11 used to set a selection way, a test button 12 used to test the modified algorithm, and a decision button 13 used to decide to modify the algorithm. The user first sets the desired selection way for “RadioButton” by checking the checkbox 11 as shown in FIG. 18. In the example of FIG. 18, the gesture “nod” is selected among the selection ways.

Then, when the user presses or clicks the test button 12, a predetermined test is performed using the GUI 10. More specifically, the device for changing settings transmits the contents of the changed setting (e.g., the information indicating the component to be changed, the information regarding the changed gesture, and the like) and the speech information used for the test to the first device 100. The speech control unit 112 of the first device 100 controls the speech output unit 130 using the speech information so that the speech output unit 130 outputs by speech sequentially the items “Radio1”, “Radio2”, and “Radio3” of the GUI 10 as shown in FIG. 19. When the user performs the gesture “nod” that is set previously, the gesture recognition unit 113 recognizes the gesture, and the input processing unit 114 analyzes the gesture on the basis of the algorithm in which the contents of the changed setting are incorporated. Then, the transmission of the analysis result from the first device 100 to the device for changing settings makes it possible for the device for changing settings to change the GUI 10 in association with the gesture. This allows the test of the modified algorithm to be achieved.

Then, when the user presses or clicks the decision button 13, it is decided to modify the algorithm. More specifically, the device for changing settings transmits the contents of the changed settings (e.g., information indicating the component to be changed, the information regarding the changed gesture, and the like) to the first device 100, and the algorithm modification unit 115 of the first device 100 incorporates the contents of the changed settings into the algorithm. In this way, the user is able to collectively modify the algorithms for the component “RadioButton” that is common to the software application A and the software application B by one setting operation. Moreover, even in a case where a plurality of software applications has common components, the algorithm can be modified only for a part of the software applications.

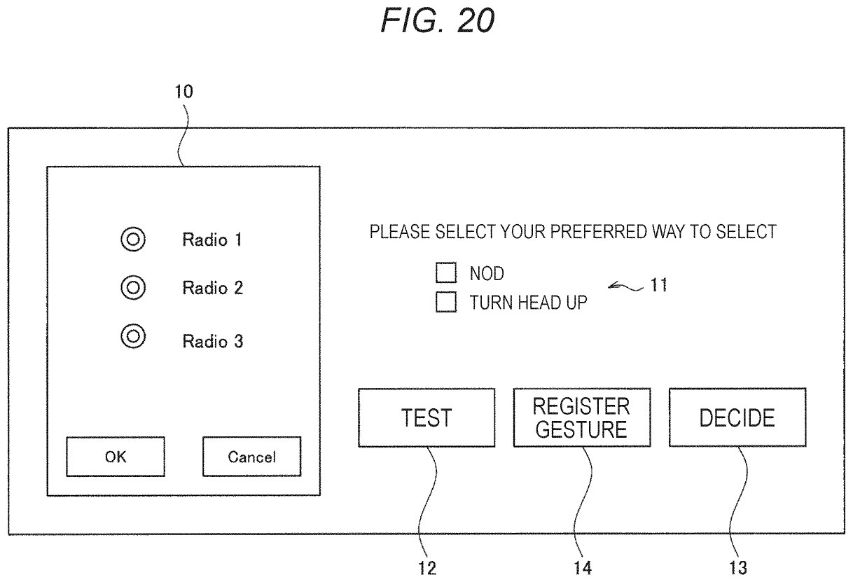

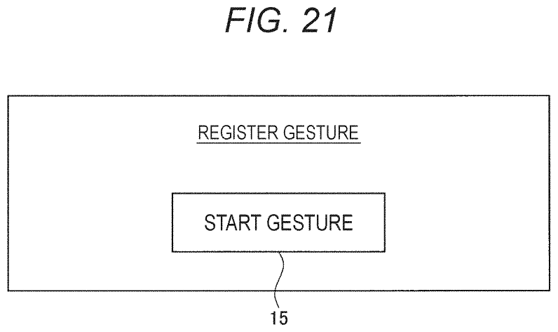

Furthermore, the user can be able to register a new gesture as a gesture performed for the input. In one example, as shown in FIG. 20, a gesture registration button 14 used to register a new gesture can be provided in the GUI. When the user presses or clicks the gesture registration button 14, in one example, a GUI having a gesture start button 15 as shown in FIG. 21 is displayed. The user performs the newly registered gesture within a predetermined length of time (e.g., within approximately 3 to 5 seconds) after pressing or clicking the gesture start button 15. More specifically, the device for changing settings transmits a predetermined signal used to notify that the gesture start button 15 is pressed to the first device 100. The registration unit 116 of the first device 100 recognizes a new gesture performed by the user within a predetermined length of time from the reception timing of the predetermined signal by analyzing the sensor information acquired by the sensor unit 140 and registers the new gesture as the gesture performed for the input.

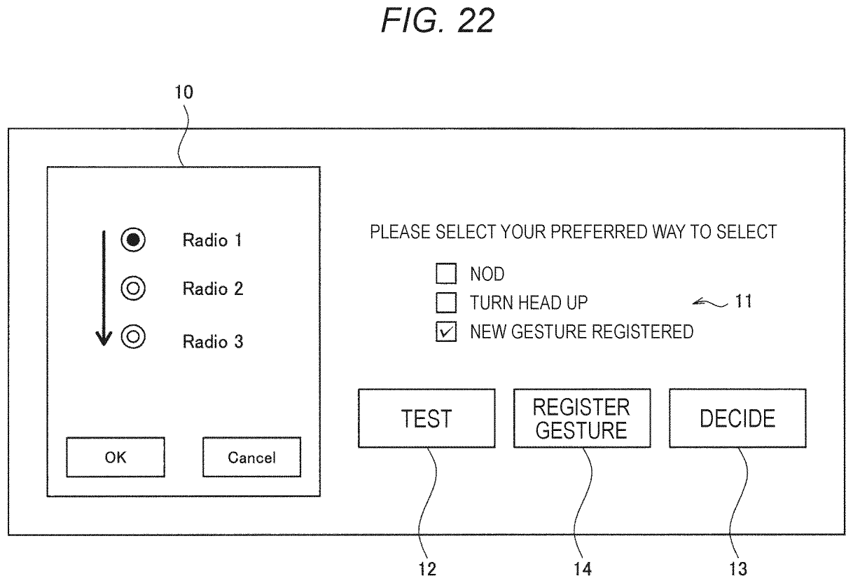

Then, in one example, as shown in FIG. 22, “registered new gesture” is added to the checkbox 11. Then, when the user presses or clicks the test button 12 in a state where the “registered new gesture” is checked, a predetermined test is performed using the GUI 10. The details of the processing performed by the first device 100 and the device for changing settings upon the test are similar to those described with reference to FIG. 19, so the description thereof will be omitted. As described above, the user is able to register a new gesture as a gesture performed for the input.

Moreover, the subject to be registered by the user is not necessarily to be the gesture alone. In one example, the user can register the gesture in a combination with the input operation with various input devices (e.g., such as buttons, various sensors, microphones, mice, keyboards, touch panels, switches, or levers). In one example, the user can register the input operation for making a gesture by pressing or clicking a button, making a gesture by holding the hand over the proximity sensor, or making a gesture by uttering some speech to the microphone. In this case, the input processing unit 114 analyzes not only the gesture but also the combination of the gesture and the input operation to the input device, on the basis of the algorithm that is uniformly defined for two or more software applications, thereby calculating the information regarding the user input.

<6. Practical Example>

The above description is given of the modification or the like of the algorithm used for the processing regarding the input. A practical example according to the present embodiment is now described.

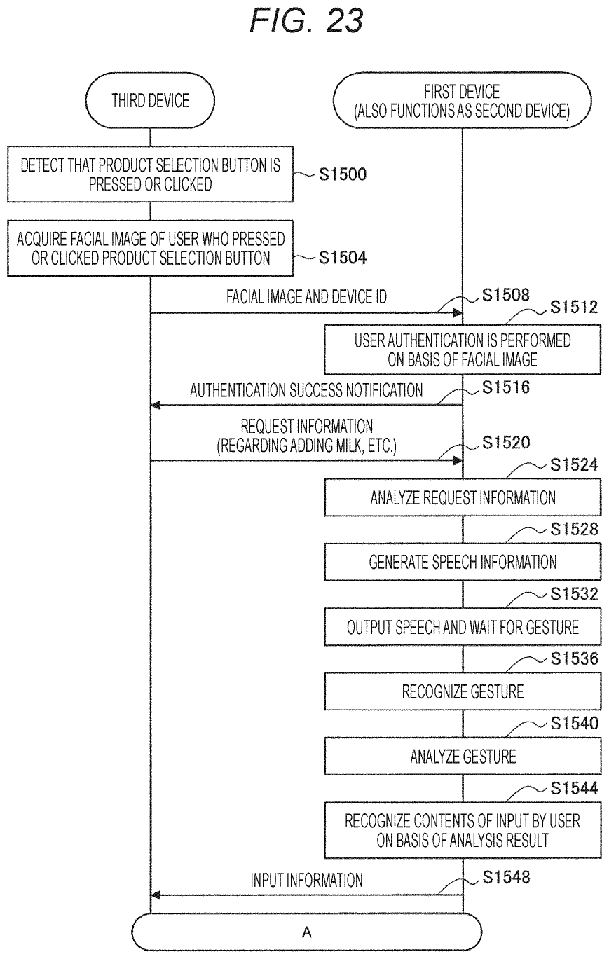

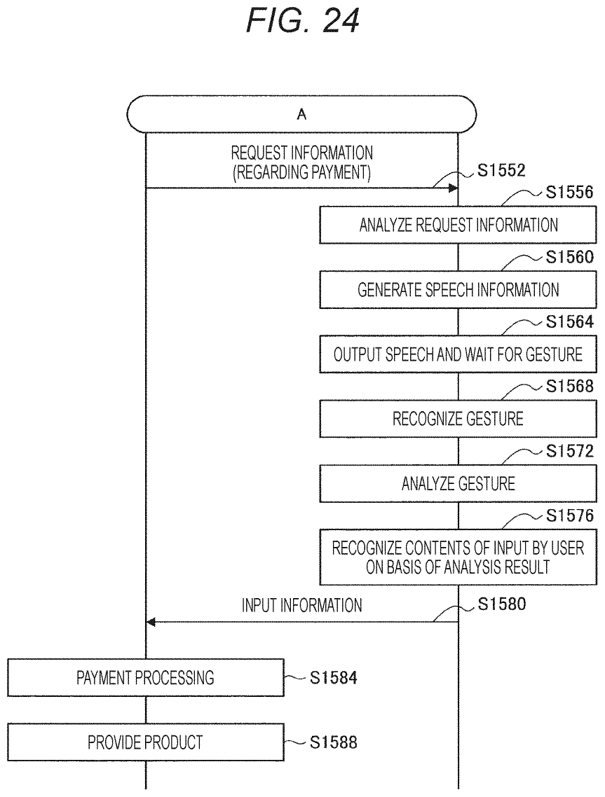

An example in which the present embodiment is applied to an automatic vending machine system to implement gesture-based payment or the like is now described with reference to FIGS. 23 and 24. More specifically, in the past, in order for a user to make a payment at an automatic vending machine, in one example, it is necessary to perform work such as holding a device equipped with a payable electronic money function over a predetermined location of the automatic vending machine. On the other hand, applying the present embodiment to the automatic vending machine system makes it possible for the user to implement the payment and the like without using the device or the like equipped with the electronic money function. Moreover, in the following practical example, it is assumed that the first device 100 also implements the function of the second device 200 (because the contents of the function implemented by each device are flexibly modifiable depending on the specifications or operations as described with reference to FIG. 1). Then, it is assumed that the first device 100 is an earphone wearable device and the third device 300 is an automatic vending machine.

In step S1500, the user presses or clicks a product selection button of the third device 300 (an automatic vending machine), and the third device 300 detects that the button is pressed or clicked. In step S1504, the third device 300 acquires a facial image of the user who pressed or clicked the product selection button, using a camera arranged toward the front of the device itself. In step S1508, the third device 300 transmits the acquired facial image and a device ID capable of identifying the third device 300 to nearby devices (including the first device 100) capable of communicating with each other using a predetermined communication scheme.

The storage unit 150 of the first device 100 stores the facial image of the user in advance, and in step S1512, the control unit 110 compares the stored facial image with the facial image provided from the third device 300, and so the user authentication is performed on the basis of the degree of similarity between them. As a result, only the first device 100 worn on the user who presses or clicks the product selection button succeeds in the user authentication. In step S1516, the first device 100 that has succeeded in the user authentication transmits an authentication success notification to the third device 300. In this regard, in one example, if the third device 300 tries to implement payment only by communication using a beacon or the like, other users located within the reachable range of the beacon or the like will also be candidates for payment. Thus, it is not possible to identify appropriately the user who is necessary to make the payment (the user who purchases the product). On the other hand, the user authentication performed using the facial image by the method mentioned above makes it possible for the third device 300 to identify appropriately the user who is necessary to make the payment (the user who purchases the product). Moreover, the information used for the user authentication is not limited to the facial image, and in one example, various types of biometric information (e.g., such as fingerprint information or iris information) can be used.

In step S1520, the third device 300 transmits various pieces of request information relating to the product (e.g., request information for checking whether milk or sugar is added to the coffee as a product, coffee strength, etc.) to the first device 100. In step S1524, the first device 100 analyzes the request information. In step S1528, the first device 100 generates speech information by performing processing such as TTS using the text information included in the request information. In step S1532, the first device 100 outputs speech using the speech information and waits for a gesture by the user. In one example, the first device 100 outputs speech such as “Do you want to add milk (or sugar)?”, “Please select the strength of coffee.”, and waits for a gesture by the user. In step S1536, the first device 100 recognizes the gesture by the user on the basis of the sensor information acquired by the sensor unit 140 or the like. In step S1540, the first device 100 analyzes the gesture to calculate information regarding the user input to the request as the analysis result. In step S1544, the first device 100 recognizes the contents of the input by the user on the basis of the analysis result. In step S1548, the first device 100 transmits the contents of the input by the user to the third device 300 as input information.

In step S1552, the third device 300 transmits request information relating to payment to the first device 100. Then, in steps S1556 to S1580, processing similar to steps S1524 to S1548 described above is performed. Moreover, in step S1564, the first device 100 outputs speech such as “Please select a payment method.”, and then a gesture input is performed. The output of the speech relating to the payment in this way makes it possible, even if the user authentication is accidentally performed, to prevent the payment processing from being performed to another person who is not the purchaser of the product (because the user to whom the speech relating to the payment is output can make a gesture to refuse payment).

In step S1584, the third device 300 performs payment processing on the basis of the input information provided from the first device 100. In one example, the third device 300 performs electronic money payment processing, credit payment processing, or the like on the basis of the payment method specified by the gesture. In a case where the payment processing is successful, in step S1588, the third device 300 provides the user with the product, and the series of processing ends. The series of processing described above makes it possible for the user to implement product selection, payment, or the like without taking out a device or the like equipped with the electronic money function.

Moreover, in the above-described practical example, the selection pattern that the user frequently selects (e.g., such as whether milk or sugar is added to the coffee product, or coffee strength) is recorded, so checking such as “Usual choice okay?” is performed, and the input processing can be shortened. In addition, the use of visible light communication or the like as the predetermined communication scheme in the above processing makes it possible to improve the success probability of communication. More specifically, in a case where an earphone wearable device or a head-mounted display is used as the first device 100, these devices are likely to be exposed to the outside at all times, so it is unlikely that the light-receiving part for visible light communication is hidden and communication is cut off. In addition, when the user authentication is performed by the facial image in the practical example mentioned above, if the user wears a mask or glasses, it is considered that the degree of similarity with the facial image stored in advance is low and the user authentication fails. In this case, it is possible to improve the success rate of the user authentication by previously accumulating a plurality of facial images acquired at various timings (e.g., such as the timing of unlocking the smartphone) and using them for the user authentication.

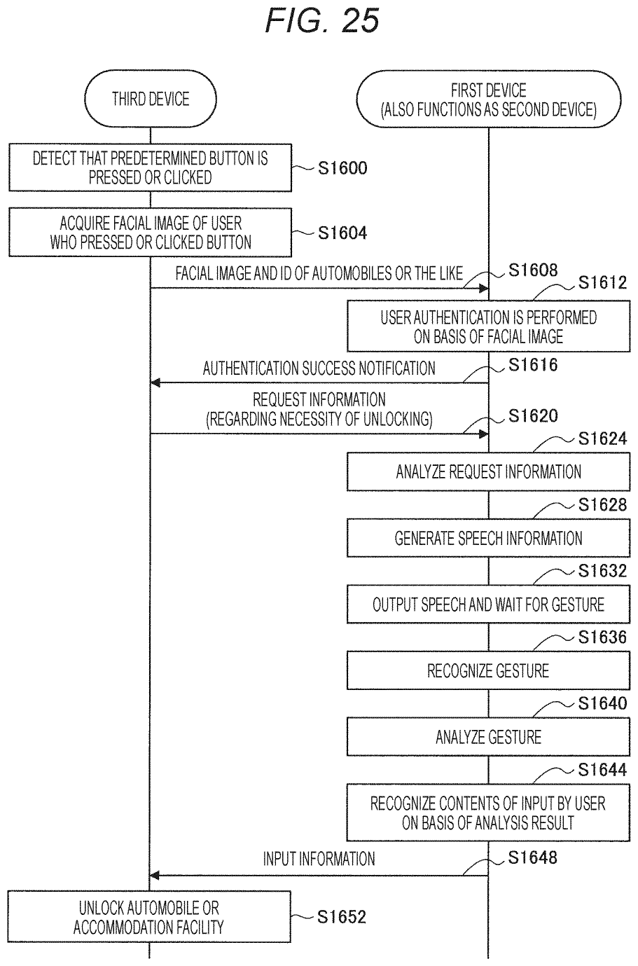

Further, the target to which the present embodiment is applicable is not limited to the automatic vending machine system. In one example, the present embodiment is applicable to a rental system for automobiles or accommodation facilities. The description is given in detail with reference to FIG. 25. FIG. 25 is a flowchart in the case where the present embodiment is applied to the rental system for automobiles or accommodation facilities to implement unlocking or the like of automobiles or accommodation facilities by a gesture. Moreover, in the present embodiment, it is assumed that the first device 100 is an earphone wearable device, and the third device 300 is an unlocking device provided on the door of an automobile or accommodation facility.

In step S1600, the user presses or clicks a predetermined button provided to the third device 300, and the third device 300 detects that the button is pressed or clicked. In step S1604, the third device 300 acquires a facial image of the user who presses or clicks the product selection button, using a camera arranged toward the front of the device itself. In step S1608, the third device 300 transmits the acquired facial image and an ID capable of identifying the automobiles or accommodation facilities to nearby devices (including the first device 100) capable of communicating with each other using a predetermined communication scheme.

The storage unit 150 of the first device 100 stores the facial image of the user in advance, and in step S1612, the control unit 110 compares the stored facial image with the facial image provided from the third device 300, and so the user authentication is performed on the basis of the degree of similarity between them. As a result, only the first device 100 worn on the user who presses or clicks the predetermined selection button succeeds in the user authentication. In step S1616, the first device 100 that has succeeded in the user authentication transmits an authentication success notification to the third device 300. This makes it possible for the third device 300 to appropriately identify the user who presses or clicks the predetermined button (the user who intends to use the automobile or the accommodation facility). Then, in one example, the third device 300 is capable of appropriately determining whether or not the identified user is the authorized user by comparing the identified user with a pre-registered authorized user, or the like. Moreover, the information used for the user authentication is not limited to the facial image, and in one example, various types of biometric information (e.g., such as fingerprint information or iris information) can be used.

In step S1620, the third device 300 transmits various pieces of request information (e.g., such as the request information for checking necessity or the like of unlocking) to the first device 100. Then, in steps S1624 to S1648, the processing similar to steps S1524 to S1548 of FIG. 23 is performed. Moreover, in step S1632, the first device 100 outputs speech such as “Do you want to unlock?”, and then performs the input by a gesture.

In step S1652, the third device 300 unlocks the automobile or the accommodation facility on the basis of the input information provided from the first device 100, and ends the series of processing. The series of processing described above makes it possible for the user to unlock the automobile or the accommodation facility without using a predetermined key or device or the like. Moreover, the target to which the present embodiment is applied is not limited to the rental system for automobiles and accommodation facilities.

<7. Hardware Configuration Example of Device>

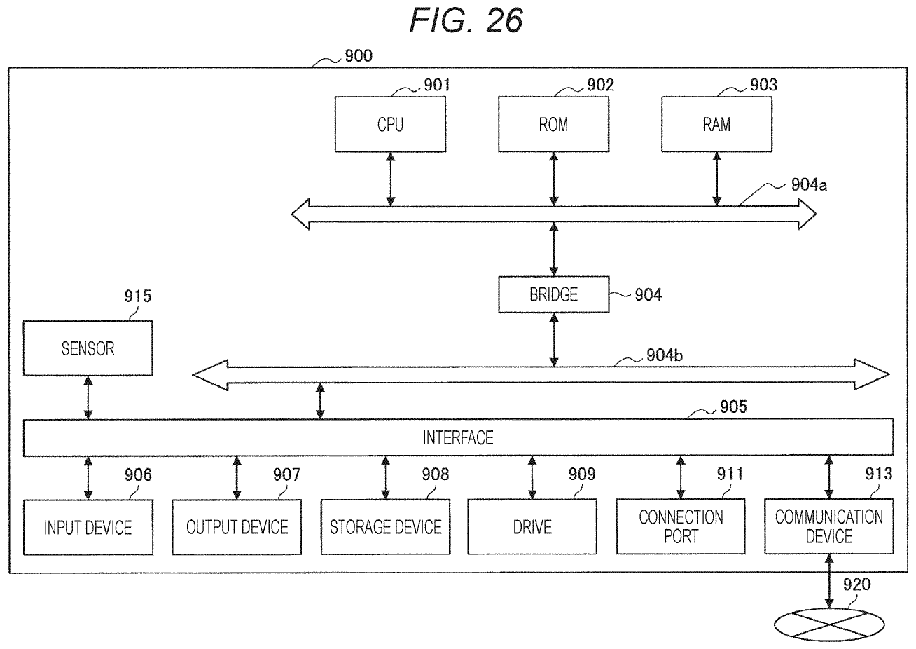

The above description is given of the practical example according to the present embodiment. A hardware configuration example of the first device 100 or the second device 200 according to the present embodiment described above is now described with reference to FIG. 26. FIG. 26 is a block diagram illustrating a hardware configuration example of an information processing apparatus 900 implementing the first device 100 or the second device 200 according to the present embodiment. The information processing performed by the first device 100 or the second device 200 according to the present embodiment is implemented by the cooperation of software and hardware described below.

As illustrated in FIG. 26, the information processing apparatus 900 includes a central processing unit (CPU) 901, a read only memory (ROM) 902, a random access memory (RAM) 903, and a host bus 904a. In addition, the information processing apparatus 900 includes a bridge 904, an external bus 904b, an interface 905, an input device 906, an output device 907, a storage device 908, a drive 909, a connection port 911, a communication device 913, and a sensor 915. The information processing apparatus 900 may include a processing circuit such as a DSP or an ASIC instead of the CPU 901 or along therewith.

The CPU 901 functions as an arithmetic processing device and a control device and controls the overall operation in the information processing apparatus 900 according to various programs. Further, the CPU 901 may be a microprocessor. The ROM 902 stores programs, operation parameters, and the like used by the CPU 901. The RAM 903 temporarily stores programs used in execution of the CPU 901, parameters appropriately changed in the execution, and the like. The CPU 901 may implement, for example, the control unit 110 of the first device 100 or the control unit 210 of the second device 200.

The CPU 901, the ROM 902, and the RAM 903 are connected by the host bus 904a including a CPU bus and the like. The host bus 904a is connected with the external bus 904b such as a peripheral component interconnect/interface (PCI) bus via the bridge 904.

Further, the host bus 904a, the bridge 904, and the external bus 904b are not necessarily separately configured and such functions may be mounted in a single bus.

The input device 906 is realized by a device through which a user inputs information, such as a mouse, a keyboard, a touch panel, a button, a microphone, a switch, and a lever, for example. In addition, the input device 906 may be a remote control device using infrared ray or other electric waves, or external connection equipment such as a cellular phone or a PDA corresponding to an operation of the information processing apparatus 900, for example. Furthermore, the input device 906 may include an input control circuit or the like which generates an input signal on the basis of information input by the user using the aforementioned input means and outputs the input signal to the CPU 901, for example. The user of the information processing apparatus 900 may input various types of data or order a processing operation for the information processing apparatus 900 by operating the input device 906.

The output device 907 is formed by a device that may visually or aurally notify the user of acquired information. As such devices, there are a display device such as a CRT display device, a liquid crystal display device, a plasma display device, an EL display device, or a lamp, an audio output device such as a speaker and a headphone, a printer device, and the like. The output device 907 may implement, for example, the speech output unit 130 of the first device 100.

The storage device 908 is a device for data storage, formed as an example of a storage unit of the information processing apparatus 900. For example, the storage device 908 is realized by a magnetic storage unit device such as an HDD, a semiconductor storage device, an optical storage device, a magneto-optical storage device, or the like. The storage device 908 may include a storage medium, a recording device for recording data on the storage medium, a reading device for reading data from the storage medium, a deletion device for deleting data recorded on the storage medium, and the like. The storage device 908 stores programs and various types of data executed by the CPU 901, various types of data acquired from the outside, and the like. The storage device 908 may implement, for example, the storage unit 150 of the first device 100 or the storage unit 230 of the second device 200.

The drive 909 is a reader/writer for storage media and is included in or externally attached to the information processing apparatus 900. The drive 909 reads information recorded on a removable storage medium such as a magnetic disc, an optical disc, a magneto-optical disc, or a semiconductor memory mounted thereon, and outputs the information to the RAM 903. In addition, the drive 909 may write information on the removable storage medium.

The connection port 911 is an interface connected with external equipment and is a connector to the external equipment through which data may be transmitted through a universal serial bus (USB) and the like, for example.

The communication device 913 is a communication interface formed by a communication device for connection to a network 920 or the like, for example. The communication device 913 is a communication card or the like for a wired or wireless local area network (LAN), long term evolution (LTE), Bluetooth (registered trademark), or wireless USB (WUSB), for example. In addition, the communication device 913 may be a router for optical communication, a router for asymmetric digital subscriber line (ADSL), various communication modems, or the like. For example, the communication device 913 may transmit/receive signals and the like to/from the Internet and other communication devices according to a predetermined protocol such as, for example, TCP/IP. The communication device 913 may implement, for example, the communication unit 120 of the first device 100 or the communication unit 220 of the second device 200.

The sensor 915 corresponds to various types of sensors such as an acceleration sensor, a gyro sensor, a pressure sensor, a geomagnetic sensor, a light sensor, a sound sensor, or a distance measuring sensor, for example. The sensor 915 acquires information regarding a state of the information processing apparatus 900 itself, such as an attitude and a movement speed of the information processing apparatus 900, and information regarding a surrounding environment of the information processing apparatus 900, such as brightness and noise of the periphery of the information processing apparatus 900. In addition, the sensor 915 may include a GPS sensor that receives a GPS signal, and measures latitude, longitude, and altitude of the device. The sensor 915 may implement, for example, the sensor unit 140 of the first device 100.

Further, the network 920 is a wired or wireless transmission path of information transmitted from devices connected to the network 920. For example, the network 920 may include a public circuit network such as the Internet, a telephone circuit network, or a satellite communication network, various local area networks (LANs) including Ethernet (registered trademark), a wide area network (WAN), and the like. In addition, the network 920 may include a dedicated circuit network such as an internet protocol-virtual private network (IP-VPN). The network 920 may implement, for example, the network 400a or the network 400b.

Hereinbefore, an example of a hardware configuration capable of realizing the functions of the information processing apparatus 900 according to this embodiment is shown. The respective components may be implemented using universal members, or may be implemented by hardware specific to the functions of the respective components. Accordingly, according to a technical level at the time when the embodiment is executed, it is possible to appropriately change hardware configurations to be used.

Note that, a computer program for realizing each of the functions of the information processing apparatus 900 according to the present embodiment as described above may be created, and may be mounted in a PC or the like. Furthermore, a computer-readable recording medium on which such a computer program is stored may be provided. The recording medium is a magnetic disc, an optical disc, a magneto-optical disc, a flash memory, or the like, for example. In addition, the above-described computer program may be distributed through, for example, a network without using a recording medium.

<8. Concluding Remark>

As described above, the information processing apparatus (the first device 100) according to the present disclosure is capable of obtaining information regarding a request from two or more software applications, recognizing a gesture made by a user who hears speech corresponding to the request, and analyzing the gesture on the basis of algorithm uniformly defined for the two or more software applications. Thus, information regarding the user input to the request is calculated.

Thus, the information processing apparatus (the first device 100) according to the present disclosure analyzes the gesture using an algorithm that is uniformly defined for two or more software applications, so the user is able to understand the common rule in the algorithm, thereby easily performing the input to the two or more software applications. In addition, as shown in FIG. 2, defining the contents of the information transmitted and received between the respective devices allows the input by the user to be achieved without depending on the type of each device. In one example, the third device 300 is capable of receiving the input from the user regardless of the types of the first device 100 and the second device 200.

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects and are not necessarily limitative. That is, with or in the place of the above effects, the technology according to the present disclosure may achieve other effects that are clear to those skilled in the art on the basis of the description of this specification.

Additionally, the technical scope of the present disclosure may also be configured as below.

(1)

An information processing apparatus including:

a reception unit configured to be capable of obtaining information regarding a request from two or more software applications;

a speech control unit configured to control an output of speech corresponding to the request;

a gesture recognition unit configured to recognize a gesture made by a user with respect to the speech corresponding to the request; and

an input processing unit configured to calculate information regarding an input by the user in response to the request by analyzing the gesture on the basis of an algorithm uniformly defined for the two or more software applications.

(2)

The information processing apparatus according to (1),

in which the request includes a request for selecting one or two or more items from two or more items, a request for changing a state of one or two or more items, or a request for selecting one value from continuous values.

(3)

The information processing apparatus according to (2),

in which the speech control unit controls the output of the speech depending on whether or not the item is selected or the state of the item.

(4)

The information processing apparatus according to (3),

in which the speech control unit causes selected items or unselected items to be collectively output as the speech or causes items having an identical state to be collectively output as the speech. (5)

The information processing apparatus according to (4),

in which the speech control unit controls the output of the speech depending on a value selected in the continuous values and a maximum value or a minimum value in the continuous values.

(6)

The information processing apparatus according to any one of (2) to (5),

in which in a case where the continuous values are selected, a displacement of a body part of the user in the gesture corresponds to each value in the continuous values.

(7)

The information processing apparatus according to any one of (1) to (6),

in which the input processing unit calculates the information regarding the input by the user by analyzing not only the gesture but also a combination of the gesture and an input operation to an input device on the basis of the algorithm.

(8)

The information processing apparatus according to any one of (1) to (7), further including:

an algorithm modification unit configured to modify the algorithm on the basis of an input from the user.

(9)

The information processing apparatus according to any one of (1) to (8), further including:

a registration unit configured to recognize the gesture made by the user or a combination of the gesture and an input operation to an input device and newly register a recognized result to be used for calculation processing of the information regarding the input by the user in the input processing unit.

(10)

The information processing apparatus according to any one of (1) to (9),

in which the reception unit is capable of obtaining the information regarding the request from an external device that obtains the request from the two or more software applications, and

the input processing unit provides the external device with the information regarding the input by the user in response to the request.

(11)

An information processing method executed by a computer, the method including:

obtaining information regarding a request from two or more software applications;

controlling an output of speech corresponding to the request;

recognizing a gesture made by a user with respect to the speech corresponding to the request; and

calculating information regarding an input by the user in response to the request by analyzing the gesture on the basis of an algorithm uniformly defined for the two or more software applications.

(12)

A program causing a computer to implement:

obtaining information regarding a request from two or more software applications;

controlling an output of speech corresponding to the request;

recognizing a gesture made by a user with respect to the speech corresponding to the request; and

calculating information regarding an input by the user in response to the request by analyzing the gesture on the basis of an algorithm uniformly defined for the two or more software applications.

### REFERENCE SIGNS LIST

100 First device
110 Control unit
111 Reception unit
112 Speech control unit
113 Gesture recognition unit
114 Input processing unit
115 Algorithm modification unit
116 Registration unit
120 Communication unit
130 Speech output unit
140 Sensor unit
150 Storage unit
200 Second device
210 Control unit
211 Speech control unit
212 Input recognition unit
220 Communication unit
230 Storage unit
300a, 300b, 300c Third device
400a, 400b Network

1. An information processing apparatus comprising:
a reception unit configured to be capable of obtaining information regarding a request from two or more software applications;
a speech control unit configured to control an output of speech corresponding to the request;
a gesture recognition unit configured to recognize a gesture made by a user with respect to the speech corresponding to the request; and
an input processing unit configured to calculate information regarding an input by the user in response to the request by analyzing the gesture on a basis of an algorithm uniformly defined for the two or more software applications.

2. The information processing apparatus according to claim 1,
wherein the request includes a request for selecting one or two or more items from two or more items, a request for changing a state of one or two or more items, or a request for selecting one value from continuous values.

3. The information processing apparatus according to claim 2,
wherein the speech control unit controls the output of the speech depending on whether or not the item is selected or the state of the item.

4. The information processing apparatus according to claim 3,
wherein the speech control unit causes selected items or unselected items to be collectively output as the speech or causes items having an identical state to be collectively output as the speech.

5. The information processing apparatus according to claim 4,
wherein the speech control unit controls the output of the speech depending on a value selected in the continuous values and a maximum value or a minimum value in the continuous values.

6. The information processing apparatus according to claim 2,
wherein in a case where the continuous values are selected, a displacement of a body part of the user in the gesture corresponds to each value in the continuous values.

7. The information processing apparatus according to claim 1,
wherein the input processing unit calculates the information regarding the input by the user by analyzing not only the gesture but also a combination of the gesture and an input operation to an input device on a basis of the algorithm.

8. The information processing apparatus according to claim 1, further comprising:
an algorithm modification unit configured to modify the algorithm on a basis of an input from the user.

9. The information processing apparatus according to claim 1, further comprising:
a registration unit configured to recognize the gesture made by the user or a combination of the gesture and an input operation to an input device and newly register a recognized result to be used for calculation processing of the information regarding the input by the user in the input processing unit.

10. The information processing apparatus according to claim 1,
wherein the reception unit is capable of obtaining the information regarding the request from an external device that obtains the request from the two or more software applications, and
the input processing unit provides the external device with the information regarding the input by the user in response to the request.

11. An information processing method executed by a computer, the method comprising:
obtaining information regarding a request from two or more software applications;
controlling an output of speech corresponding to the request;
recognizing a gesture made by a user with respect to the speech corresponding to the request; and
calculating information regarding an input by the user in response to the request by analyzing the gesture on a basis of an algorithm uniformly defined for the two or more software applications.

12. A program causing a computer to implement:
obtaining information regarding a request from two or more software applications;
controlling an output of speech corresponding to the request;
recognizing a gesture made by a user with respect to the speech corresponding to the request; and
calculating information regarding an input by the user in response to the request by analyzing the gesture on a basis of an algorithm uniformly defined for the two or more software applications.
